(19) United States
(12) Patent Application Publication
(10) Pub. No.: US 2026/0015227 A1
(43) Pub. Date: Jan. 15, 2026

(54) AMMONIA CRACKING VIA IN-SITU NITROGEN SEPARATION

(71) Applicant: Saudi Arabian Oil Company, Dhahran (SA)

(72) Inventors: Osamah Siddiqui, Dhahran (SA); Bandar Solami, Dammam (SA); Mohammad Abdur Rakib, Dhahran (SA)

(21) Appl. No.: 18/770,176

(22) Filed: Jul. 11, 2024

(51) Int. Cl. C01B 3/04; B01D 53/04; B01D 53/08; B01J 20/22; B01J 20/28; C01B 3/56

(52) U.S. Cl. CPC C01B 3/047; B01D 53/04; B01D 53/08; B01J 20/226; B01J 20/28004; B01J 20/28064; B01J 20/28066; C01B 3/56; B01D 2253/204; B01D 2256/16; B01D 2257/102; B01D 2259/40088; C01B 2203/0277; C01B 2203/0425; C01B 2203/043

(57) ABSTRACT

A fixed adsorbent and catalyst bed containing system includes two or more first reactors in a reaction (RM) mode and two or more second reactors in a regeneration (RGM) mode that are sequentially operable and positioned in parallel. The two or more first reactors in the RM mode are configured to simultaneously in-situ decompose NH₃ by a catalyst and selectively adsorb N₂ by an adsorbent. At a substantially same time, the two or more second reactors in the RGM mode are configured to continuously regenerate the catalyst after decomposing the NH₃ and the adsorbent after adsorbing the N₂. A moving adsorbent bed and fixed catalyst bed containing system and a dual fluidized bed containing system are also provided. The present invention also relates to methods for decomposing ammonia (NH₃) to nitrogen (N₂) and hydrogen (H₂).

### TECHNICAL FIELD

The present disclosure relates to systems and methods for ammonia (NH₃) decomposition, more particularly, to systems and methods for decomposing NH₃ to hydrogen (H₂) and nitrogen (N₂) via in-situ nitrogen separation.

### BACKGROUND

Hydrogen (H₂) is a clean energy source for meeting global energy demands and reducing carbon emissions. However, challenges in the storage and transportation of H₂ hinder its widespread adoption. Ammonia (NH₃) is an alternative H₂ carrier due to its carbon-free nature.

Conventionally, NH₃ decomposition into H₂ and N₂ involves complex separation steps for ammonia, nitrogen, and hydrogen. These separation steps render the process inefficient for industrial ammonia cracking. Accordingly, there is a need to develop more efficient and integrated systems and methods for NH₃ decomposition.

### SUMMARY

In one exemplary embodiment, a fixed adsorbent and catalyst bed containing system for ammonia (NH₃) decomposition contains two or more first reactors in a reaction mode (RM) that are placed parallel to each other. In some embodiments, each of the two or more first reactors includes a first gas inlet, a first gas outlet, and a first fixed adsorbent and catalyst bed including a catalyst for decomposing NH₃ to a gas mixture containing nitrogen (N₂) and hydrogen (H₂), and a N₂ selective adsorbent for in-situ adsorbing N₂ from the gas mixture to form a product gas stream leaving the first reactor from the first gas outlet. The fixed adsorbent and catalyst bed containing system further includes two or more second reactors in a regeneration mode (RGM) that are placed parallel to each other. In some embodiments, each of the two or more second reactors includes a second gas inlet, a second gas outlet, and a second fixed adsorbent and catalyst bed containing a spent catalyst and a N₂-containing adsorbent.

In some embodiments, the two or more first reactors in the RM mode and the two or more second reactors in the RGM mode are sequentially operable and positioned in parallel. In some embodiments, the two or more first reactors are configured to simultaneously in-situ decompose NH₃ and selectively adsorb N₂ in the first fixed adsorbent and catalyst bed. In some embodiments, the two or more second reactors are configured to continuously regenerate the catalyst from the spent catalyst and the N₂ selective adsorbent from the N₂-containing adsorbent in the second fixed adsorbent and catalyst bed.

In some embodiments, the two or more first reactors are changed to the RGM mode after decomposing the NH₃, and the two or more second reactors are changed to the RM mode at a substantially same time when the two or more first reactors are changed to the RGM mode.

In some embodiments, the two or more first reactors share a same ammonia source. In some embodiments, the ammonia source is in fluid communication with each of the two or more first reactors via the first gas inlet.

In some embodiments, the N₂ selective adsorbent present in the two or more first reactors is in the form of particles having an average particle size ranging from about 100 nanometers (nm) to about 10 micrometers (μm).

In some embodiments, the N₂ selective adsorbent present in the two or more first reactors has a surface area of about 600 to about 4500 square meters per gram (m²/g).

In some embodiments, the N₂ selective adsorbent present in the two or more first reactors is selected from the group consisting of metal organic frameworks (MOFs), covalent organic frameworks (COFs), zeolitic imidazolate frameworks (ZIFs), and combinations thereof.

In some embodiments, the N₂ selective adsorbent present in the two or more first reactors is a MOF. In some embodiments, the MOF contains at least one metal selected from the group consisting of titanium, vanadium, chromium, manganese, iron, cobalt, nickel, and copper.

In some embodiments, the catalyst present in the two or more first reactors contains three metals selected from the group consisting of barium (Ba), cobalt (Co), cerium (Ce), nickel (Ni), ruthenium (Ru), iron (Fe), platinum (Pt), palladium (Pd), rhodium (Rh), molybdenum (Mo), copper (Cu), and vanadium (V).

In some embodiments, the fixed adsorbent and catalyst bed containing system further includes a plurality of throttling valves, two polishers, and two separators (SEPs).

In some embodiments, the first gas outlet of the first reactor in the RM mode is in fluid communication with a first polisher via at least one of the plurality of throttling valves. In some embodiments, the first polisher separates unreacted NH₃ from the product gas stream originated from the first gas outlet, thereby generating a first polished product gas stream containing H₂ and N₂.

In some embodiments, the first polisher is a water-based ammonia absorber or a pressure swing adsorption (PSA) based ammonia adsorber.

In some embodiments, the first polished product gas stream is introduced into a first SEP to separate H₂ and N₂, thereby generating a H₂-containing gas stream and a first N₂-containing gas stream.

In some embodiments, the two or more second reactors in the RGM mode share a same nitrogen source. In some embodiments, the nitrogen source is in fluid communication with each of the two or more second reactors in the RGM mode via the second gas inlet.

In some embodiments, the second gas outlet of the second reactor in the RGM mode is in fluid communication with a second polisher via at least one of the plurality of throttling valves. In some embodiments, the second polisher is in fluid communication with a second SEP.

In some embodiments, the two or more second reactors in the RGM mode are heated during regeneration of the catalyst and adsorbent in the second fixed adsorbent and catalyst bed.

In some embodiments, the two or more second reactors in the RGM mode are pressurized during regeneration of the catalyst and adsorbent in the second fixed adsorbent and catalyst bed.

In some embodiments, the adsorbent of the second fixed adsorbent and catalyst bed after the regeneration has an average particle size ranging from about 100 nm to about 10 μm and a surface area of about 600 to about 4500 m²/g.

In some embodiments, the adsorbent in the first fixed adsorbent and catalyst bed is saturated with N₂ at a substantially same time as the regeneration of the adsorbent in the second fixed adsorbent and catalyst bed.

In one exemplary embodiment, a method for decomposing ammonia (NH₃) to nitrogen (N₂) and hydrogen (H₂) includes splitting and introducing an NH₃-containing feed gas stream into two of more first reactors in a reaction (RM) mode via a first gas inlet. In some embodiments, each of the two of more first reactors in the RM mode includes the first gas inlet, a first gas outlet, and a first fixed adsorbent and catalyst bed including a catalyst for decomposing NH₃ to a gas mixture comprising N₂ and H₂, and a N₂ selective adsorbent for in-situ adsorbing N₂ from the gas mixture.

The method further includes contacting the NH₃-containing feed gas with the catalyst and adsorbent disposed in the first fixed adsorbent and catalyst bed to form a first N₂-containing adsorbent and a product gas stream leaving the first reactor in the RM mode via the first gas outlet. The method further includes at a substantially same time of the splitting and introducing the NH₃-containing feed gas stream, splitting and introducing a N₂-containing feed gas stream into two or more second reactors in the regeneration mode (RGM) via a second gas inlet. In some embodiments, each of the two or more second reactors in the RGM mode includes the second gas inlet, a second gas outlet, and a second fixed adsorbent and catalyst bed containing an NH₃-containing spent catalyst and a second N₂-containing adsorbent. The method further includes heating or pressurizing the second fixed adsorbent and catalyst bed to release the N₂ from the second N₂-containing adsorbent and the NH₃ from the NH₃-containing spent catalyst, thereby regenerating the N₂ selective adsorbent and the catalyst. The method further includes changing the two or more first reactors to the RGM mode after the decomposing the NH₃, and the two or more second reactors to the RM mode at a substantially same time. In some embodiments, the two or more first reactors and the two or more second reactors are sequentially operable and positioned in parallel.

The method also includes introducing the product gas stream from the two or more first reactors in the RM mode to a first polisher via one of the plurality of throttling valves. In some embodiments, the first polisher is configured to separate unreacted NH₃ from the product gas stream and form a first polished product gas stream containing H₂ and N₂. The method further includes introducing the first polished product gas stream into a first separator (SEP) to separate H₂ and N₂, thereby generating a H₂-containing gas stream and a first N₂-containing gas stream.

The method also includes introducing the first N₂-containing gas stream into the two or more second reactors in the RGM mode via the second gas inlet. The method further includes combining the first N₂-containing gas stream, the N₂ released from the second N₂-containing adsorbent, and the NH₃ released from the NH₃-containing spent catalyst to form a N₂-containing product gas stream leaving the second reactor via the second gas outlet. The method further includes introducing the N₂-containing product gas stream into a second polisher via one of the plurality of throttling valves. In some embodiments, the second polisher is configured to separate NH₃ from the N₂-containing product gas stream.

In one exemplary embodiment, a moving adsorbent bed and fixed catalyst bed containing system includes a reactor in the form of a cylinder having a central longitudinal axis. In some embodiments, the reactor includes a perforated cylindrical tube at the center of the reactor extending along the central longitudinal axis and a cavity formed between an outer side wall of the perforated cylindrical tube and an inner side wall of the reactor. The moving adsorbent bed and fixed catalyst bed system further includes an ammonia (NH₃) gas inlet disposed at an uppermost point of the perforated cylindrical tube, a product gas stream outlet disposed at the bottommost point of the perforated cylindrical tube, an adsorbent inlet at the uppermost point of the cavity, and an adsorbent outlet at the bottommost point of the cavity. In some embodiments, an NH₃ decomposition catalyst is uniformly distributed throughout the perforated cylindrical tube, thereby forming the fixed catalyst bed. In some embodiments, an adsorbent is uniformly distributed throughout the cavity, thereby forming the moving adsorbent bed.

In some embodiments, a mean particle size of the adsorbent is at least about 10% larger than an average hole size of the perforated cylindrical tube.

In some embodiments, an NH₃ source is in fluid communication with the reactor via the NH₃ gas inlet.

In some embodiments, the moving adsorbent bed and fixed catalyst bed containing system also includes a waste heat recovery unit (WHR), a separator (SEP), a regenerator, a regenerator pump, and a polisher. In some embodiments, the WHR is in thermal communication with the regenerator.

In some embodiments, the reactor is in fluid communication with the WHR via the product gas stream outlet. In some embodiments, the WHR is in fluid communication with the polisher.

In some embodiments, the reactor is in mass and fluid communications with the SEP via the adsorbent outlet. In some embodiments, the SEP is in fluid communication with the polisher. In some embodiments, the SEP is in mass communication with the regenerator.

In some embodiments, the regenerator is in mass communication with the cavity of the reactor via the adsorbent inlet.

In one exemplary embodiment, a method for decomposing ammonia (NH₃) includes introducing an NH₃-containing gas stream into the reactor of the system via the NH₃ gas inlet, and contacting the NH₃-containing gas stream with the NH₃ decomposition catalyst disposed on the fixed catalyst bed, thereby generating N₂ and H₂.

In one exemplary embodiment, a moving adsorbent bed and fixed catalyst bed containing system includes a reactor in the form of a cylinder having a central longitudinal axis. In some embodiments, the reactor contains a perforated cylindrical tube at the center of the reactor extending along the central longitudinal axis and a cavity formed between an outer side wall of the perforated cylindrical tube and an inner side wall of the reactor, an ammonia (NH₃) gas inlet disposed at an uppermost point of the cavity, a product gas stream outlet disposed at the bottommost point of the cavity, an adsorbent inlet at the uppermost point of the perforated cylindrical tube, and an adsorbent outlet at the bottommost point of the perforated cylindrical tube.

In some embodiments, an NH₃ decomposition catalyst is uniformly distributed throughout the cavity, thereby forming the fixed catalyst bed.

In some embodiments, an adsorbent is uniformly distributed throughout the perforated cylindrical tube, thereby forming the moving adsorbent bed.

In some embodiments, a mean particle size of the adsorbent is at least 10% larger than an average hole size of the perforated cylindrical tube.

In some embodiments, an NH₃ source is in fluid communication with the reactor via the NH₃ gas inlet.

In some embodiments, the moving adsorbent bed and fixed catalyst bed containing system further includes a waste heat recovery unit (WHR), a separator (SEP), a regenerator, a regenerator pump, and a polisher. In some embodiments, the WHR is in thermal communication with the regenerator.

In some embodiments, the reactor is in fluid communication with the WHR via the product gas stream outlet. In some embodiments, the WHR is in fluid communication with the polisher.

In some embodiments, the reactor is in mass and fluid communications with the SEP via the adsorbent outlet. In some embodiments, the SEP is in fluid communication with the polisher.

In some embodiments, the SEP is in mass communication with the regenerator.

In some embodiments, the regenerator is in mass communication with the perforated cylindrical tube of the reactor via the adsorbent inlet.

In one exemplary embodiment, a method for decomposing ammonia (NH₃) includes introducing an NH₃-containing gas stream into the reactor of the system via the NH₃ gas inlet, and contacting the NH₃-containing gas stream with the NH₃ decomposition catalyst disposed on the fixed catalyst bed, thereby generating N₂ and H₂.

In one exemplary embodiment, a dual fluidized bed containing system includes a first fluidized bed reactor in the form of a cylinder having a first ammonia (NH₃) gas inlet disposed at a first bottom point of the first fluidized bed reactor, a second inlet disposed at a second bottom point of the first fluidized bed reactor, a product gas stream outlet disposed at a top point of the first fluidized bed reactor, a solid product outlet disposed on an outer side wall of an upper body portion of the first fluidized bed reactor, an adsorbent, and a catalyst. The dual fluidized bed containing system further includes a second fluidized bed reactor in the form of a cylinder having a first N₂ gas inlet disposed at a first bottom point of the second fluidized bed reactor, a regenerated solid product outlet disposed at a second bottom point of the second fluidized bed reactor, a N₂ gas outlet disposed at a first top point of the second fluidized bed reactor, and a solid product inlet disposed on an outer side wall of a lower body portion of the second fluidized bed reactor. In some embodiments, the first fluidized bed reactor and the second fluidized bed reactor are positioned parallel to each other in the same horizontal plane. In some embodiments, the solid product outlet of the first fluidized bed reactor is located at a position higher than the solid product inlet of the second fluidized bed reactor relative to the same horizontal plane of the first fluidized reactor and the second fluidized reactor.

In some embodiments, the adsorbent and the catalyst are homogenously distributed thorough the first fluidized bed reactor.

In some embodiments, the dual fluidized bed containing system further includes a polisher, a separator (SEP), and a plurality of throttling valves.

In one exemplary embodiment, a method for decomposing ammonia (NH₃) includes introducing an NH₃-containing gas stream into the first fluidized bed reactor of the system via the first NH₃ gas inlet, and contacting the NH₃-containing gas stream with the adsorbent and the catalyst homogenously distributed thorough the first fluidized bed reactor, thereby generating to N₂ and H₂.

### BRIEF DESCRIPTION OF THE DRAWINGS

FIG. 1 is a schematic diagram illustrating a first step of a fixed adsorbent and catalyst bed containing system 1000 for ammonia (NH₃) decomposition, according to certain embodiments of the present disclosure.

FIG. 2 is a schematic diagram illustrating a second step of the fixed adsorbent and catalyst bed containing system 1000 for NH₃ decomposition, according to certain embodiments of the present disclosure.

FIG. 3 is an example schematic of a moving adsorbent bed and fixed catalyst bed containing system 3000 for NH₃ decomposition, according to certain embodiments of the present disclosure.

FIG. 4 is an example schematic of a moving adsorbent bed and fixed catalyst bed containing system 4000 for NH₃ decomposition, according to certain embodiments of the present disclosure.

FIG. 5 is an example schematic of a dual fluidized bed containing system 5000 for NH₃ decomposition, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “particle size” and “pore size” are thought of as the lengths or longest dimensions of a particle and of a pore opening, respectively.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the terms “metal organic framework,” or “MOF,” refer to a coordination network with organic ligands containing potential voids. A coordination network is a coordination compound extending, through repeating coordination entities, in one dimension, but with cross-links between two or more individual chains, loops, or spiro-links, or a coordination compound extending through repeating coordination entities in two or three dimensions. A coordination entity is an ion or neutral molecule that is composed of a central atom, usually that of a metal, to which is attached a surrounding array of atoms or groups of atoms, each of which is called a ligand. More succinctly, a metal organic framework is characterized by metal ions or clusters coordinated to organic ligands to form one-, two-, or three-dimensional structures. A MOF exhibits a regular void or pore structure. The nature of the void or pore structure may be impacted by various properties or structural factors. These properties include the geometry of the metal ions or clusters, the arrangement of the linkages between metal ions or clusters, and the number, identity, and spatial arrangement of voids or pores. These properties may be described as the structure of the repeat units and the nature of the arrangement of the repeat units. The specific structure of the MOF, which may include the void or pore structure, is referred to as the MOF topology.

MOF-containing imidazole or benzimidazole ligands are referred to as zeolitic imidazolate frameworks (ZIFs). As used herein, the terms “zeolitic,” “zeolite,” or “zeolitic materials” refer to a material having the crystalline structure or three-dimensional framework of a zeolite. Zeolites are porous silicate or aluminosilicate minerals that occur in nature. Elementary building units of zeolites are SiO₄ (and if appropriate, AlO₄) tetrahedra. Adjacent tetrahedra are linked at their corners via a common oxygen atom, which results in an inorganic macromolecule with a three-dimensional framework (also referred to as the zeolite framework). The three-dimensional framework of a zeolite also includes channels, channel intersections, and cages having dimensions in the range of about 0.1 to about 10 nm, such as about 0.2 to about 5 nm, or about 0.2 to about 2 nm. Water molecules may be present inside these channels, channel intersections, and/or cages. Zeolites which are devoid of aluminum may be referred to as “all-silica zeolites” or “aluminum-free zeolites”. Some zeolites which are substantially free of, but not devoid of aluminum, are referred to as “high-silica zeolites”.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the forgoing, one objective of the present disclosure is to provide a fixed adsorbent and catalyst bed containing system for NH₃ decomposition, and a method of using the system for decomposing NH₃ to H₂ and N₂. A second objective of the present disclosure is to provide a moving adsorbent bed and fixed catalyst bed containing system, and a method of using the system for decomposing NH₃ to H₂ and N₂. A third objective of the present disclosure is to provide a moving adsorbent bed and fixed catalyst bed containing system, and a method of using the system for decomposing NH₃ to H₂ and N₂. A fourth objective of the present disclosure is to provide a dual fluidized bed containing system, and a method of using the system for decomposing NH₃ to H₂ and N₂.

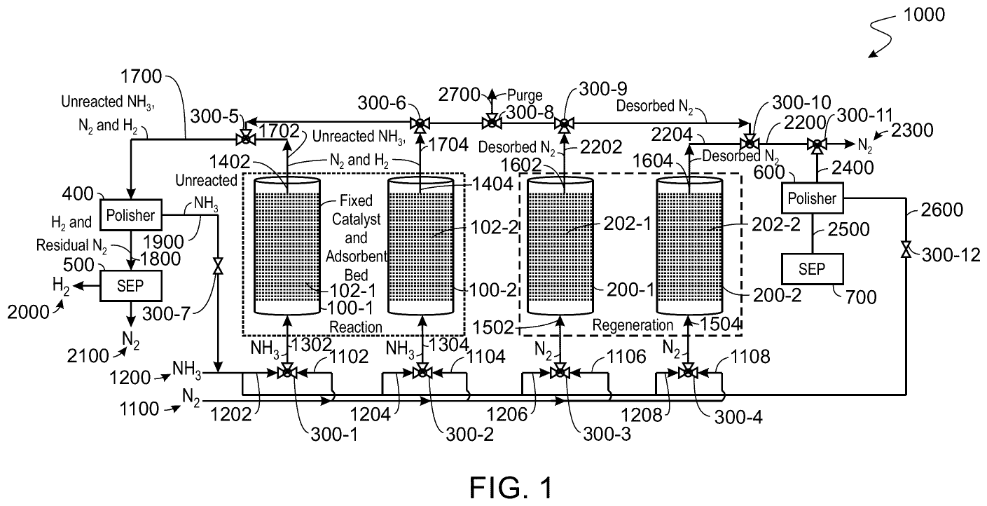

Provided in the present disclosure are systems and methods for ammonia cracking through in-situ ammonia decomposition and product adsorption. The in-situ selective adsorption of produced nitrogen during the catalytic decomposition of ammonia decreases the concentration of formed products during the reaction, thereby increasing the reaction rate based on Le Chatelier's principle. Additionally, methods of the present disclosure involve in-situ separation of nitrogen from a gaseous mixture of ammonia, hydrogen, and nitrogen. The ammonia decomposition systems of the present disclosure include, but are not limited to, sequentially operated fixed catalyst-adsorbent beds, moving adsorbent bed with fixed catalyst bed and fluidized beds with sequential regeneration, as depicted in FIGS. 1-5.

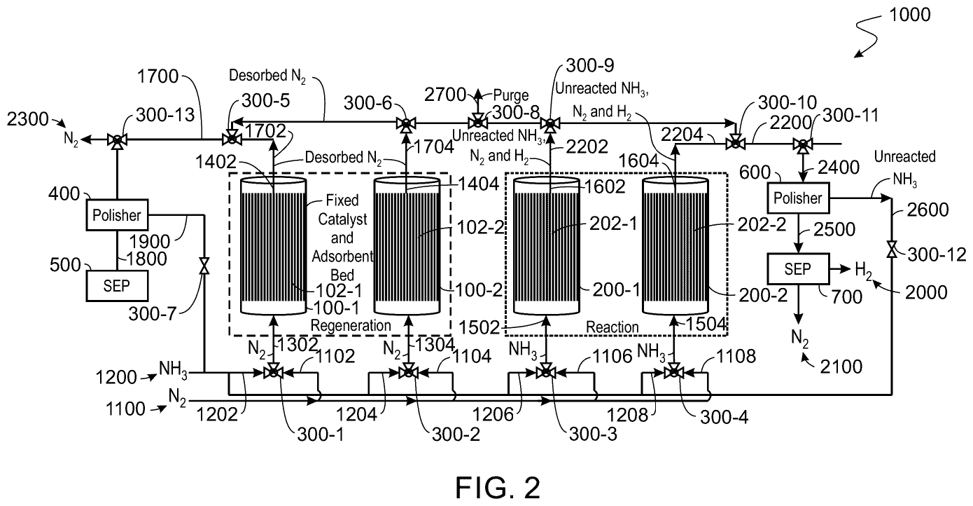

FIGS. 1 and 2 are schematic diagrams illustrating a first step and second step of a fixed adsorbent and catalyst bed containing system 1000 for ammonia (NH₃) decomposition. The system 1000 includes multiple reactors to attain continuous ammonia decomposition via sequential adsorption and desorption steps in the reactors as illustrated in FIGS. 1 and 2.

Referring to FIG. 1, the system 1000 includes two or more first reactors (100-1 and 100-2) in a reaction (RM) mode that are placed parallel to each other. In some embodiments, a foremost first reactor (100-1) in the RM mode contains a foremost first gas inlet (1302), a foremost first gas outlet (1402), and a foremost first fixed adsorbent and catalyst bed (102-1). In some embodiments, the foremost first fixed adsorbent and catalyst bed (102-1) contains a catalyst for decomposing NH₃ introduced from the first gas inlet (1302) to a gas mixture containing nitrogen (N₂) and hydrogen (H₂). In some embodiments, the foremost first fixed adsorbent and catalyst bed (102-1) also contains a N₂ selective adsorbent for in-situ adsorbing N₂ from the gas mixture to form a product gas stream (1702) leaving the foremost first reactor (100-1) from the foremost first gas outlet (1402).

In some embodiments, a last first reactors (100-2) in the RM mode contains a last first gas inlet (1304), a last first gas outlet (1404), and a last first fixed adsorbent and catalyst bed (102-2). In some embodiments, the last first fixed adsorbent and catalyst bed (102-2) contains the catalyst for decomposing NH₃ introduced from the last first gas inlet (1304) to a gas mixture containing N₂ and H₂. In some embodiments, the last first fixed adsorbent and catalyst bed (102-2) also contains the N₂ selective adsorbent for in-situ adsorbing N₂ from the gas mixture to form a product gas stream (1704) leaving the last first reactor (100-2) from the last first gas outlet (1404).

In some embodiments, the N₂ selective adsorbent present in the two or more first reactors (100-1 and 100-2) is in the form of particles having an average particle size ranging from about 100 nanometers (nm) to about 10 micrometers (μm), such as about 200 nm to about 8 μm, about 400 nm to about 6 μm, about 600 nm to about 4 μm, about 800 nm to about 2 μm, or about 1 μm to about 1.5 μm, or about 100 nm, about 300 nm, about 500 nm, about 700 nm, about 900 nm, about 1.1 μm, about 1.5 μm, about 2 μm, about 2.5 μm, about 3 μm, about 3.5 μm, about 4 μm, about 4.5 μm, or about 5 μm.

In some embodiments, the N₂ selective adsorbent present in the two or more first reactors (100-1 and 100-2) has a surface area of about 600 to about 4500 square meters per gram (m²/g), such as about 800 to about 4300 m²/g, about 1000 to about 4100 m²/g, about 1200 to about 3900 m²/g, about 1400 to about 3700 m²/g, about 1600 to about 3500 m²/g, about 1800 to about 3300 m²/g, about 2000 to about 3100 m²/g, about 2200 to about 2900 m²/g, about 2400 to about 2700 m²/g, or about 2500 to about 2600 m²/g, or about 600 m²/g, about 900 m²/g, about 1200 m²/g, about 1500 m²/g, about 1800 m²/g, about 2100 m²/g, about 2400 m²/g, about 2700 m²/g, about 3000 m²/g, about 3300 m²/g, about 3600 m²/g, about 3900 m²/g, about 4200 m²/g, or about 4500 m²/g.

In some embodiments, the N₂ selective adsorbent present in the two or more first reactors (100-1 and 100-2) is selected from the group consisting of metal organic frameworks (MOFs), covalent organic frameworks (COFs), zeolitic imidazolate frameworks (ZIFs), and combinations thereof. In further embodiments, the adsorbent is a MOF. In further embodiments, the adsorbent is a COF. In further embodiments, the adsorbent is a ZIF. In further embodiments, the MOF includes at least one metal selected from the group consisting of titanium, vanadium, chromium, manganese, iron, cobalt, nickel, and copper. In further embodiments, the COF includes at least one metal selected from the group consisting of titanium, vanadium, chromium, manganese, iron, cobalt, nickel, and copper. In further embodiments, the ZIF includes at least one metal selected from the group consisting of titanium, vanadium, chromium, manganese, iron, cobalt, nickel, and copper. In further embodiments, the MOF includes vanadium. In further embodiments, the COF includes vanadium. In further embodiments, the ZIF includes vanadium. In some embodiments, vanadium (II)-based MOFs are used as the adsorbent for selective N₂ adsorption.

In some embodiments, the catalyst present in the two or more first reactors (100-1 and 100-2) includes three metals selected from the group consisting of barium (Ba), cobalt (Co), cerium (Ce), nickel (Ni), ruthenium (Ru), iron (Fe), platinum (Pt), palladium (Pd), rhodium (Rh), molybdenum (Mo), copper (Cu), and vanadium (V). In further embodiments, the catalyst includes barium, cobalt, nickel, and cerium. In further embodiments, the catalyst is a barium-promoted cobalt-cerium catalyst.

Also, referring to FIG. 1, the system 1000 further includes a plurality of throttling valves (300-1 to 300-12), two polishers (400 and 600), and two separators (SEPs) (500 and 700). In some embodiments, the plurality of throttling valves (300-1 to 300-12) are configured to regulate and control fluid flow through the throttle valve, for example, by varying feed gas streams flowing through the throttle valve corresponding to the mode of operation of the system 1000. In some embodiments, the two polishers (400 and 600) are configured to separate ammonia from an ammonia containing mixture. In some embodiments, the two SEPs (500 and 700) are configured to separate N₂ from H₂, or separate H₂ from N₂.

In some embodiments, the two or more first reactors (100-1 and 100-2) share a same ammonia source (1200). In some embodiments, the ammonia source (1200) is split into two or more ammonia feed streams (1202 and 1204) via two or more throttling valves (300-1 and 300-2). In some embodiments, the ammonia source (1200) is in fluid communication with each of the two or more first reactors (100-1 and 100-2) via the corresponding first gas inlet (1302 and 1304).

In some embodiments, the foremost first gas outlet (1402) of the foremost first reactor (100-1) in the RM mode is in fluid communication with a first polisher (400) via one of the plurality of throttling valves (300-5). In some embodiments, a last first gas outlet (1404) of the first reactor (100-2) in the RM mode is in fluid communication with a first polisher (400) via at least one of the plurality of throttling valves (300-5 and 300-6). In some embodiments, the product gas stream (1700) includes a foremost first product gas stream (1702) and a last first product gas stream (1704) originated from the two or more first reactors (100-1 and 100-2), respectively.

In some embodiments, the first polisher (400) separates unreacted NH₃ from the product gas stream (1700) originated from the foremost first and last first gas outlets (1402 and 1404), thereby generating a first NH₃ recycle stream (1900) and a first polished product gas stream (1800) containing H₂ and N₂. In some embodiments, the first polished product gas stream (1800) is introduced into a first SEP (500) to separate H₂ and N₂, thereby generating a H₂-containing gas stream (2000) and a first N₂-containing gas stream (2100). In some embodiments, the first polisher (400) is a water-based ammonia absorber or a pressure swing adsorption (PSA) based ammonia adsorber. In further embodiments, the first polisher (400) is a PSA based ammonia adsorber. In some embodiments, the first SEP (500) is a PSA-based selective nitrogen adsorber or a PSA-based selective hydrogen adsorber. In some embodiments, the first NH₃ recycle stream (1900) is configured to flow into the ammonia source (1200) via a throttling valve (300-7).

Also, referring to FIG. 1, the system 1000 also includes two or more second reactors (200-1 and 200-2) in a regeneration (RGM) mode that are placed parallel to each other. In some embodiments, a foremost second reactor (200-1) contains a foremost second gas inlet (1502), a foremost second gas outlet (1602), and a foremost second fixed adsorbent and catalyst bed (202-1) containing a spent catalyst and a N₂-containing adsorbent. In some embodiments, the spent catalyst has the same structure and composition as the catalyst from the two or more first reactors (100-1 and 100-2) after decomposing the NH₃. In some embodiments, the N₂-containing adsorbent has the same structure and composition as the N₂ selective adsorbent from the two or more first reactors (100-1 and 100-2) after adsorbing the N₂.

In some embodiments, a last second reactor (200-1) in the RGM mode contains a last second gas inlet (1504), a last second gas outlet (1604), and a last second fixed adsorbent and catalyst bed (202-2) containing the catalyst after the spent catalyst and the N₂-containing adsorbent.

In some embodiments, the two or more second reactors (200-1 and 200-2) in the RGM mode share a same nitrogen source (1100). The nitrogen source (1100) is split into two or more nitrogen feed streams (1106 and 1108) via two or more throttling valves (300-3 and 300-4). In some embodiments, the nitrogen source (1100) is in fluid communication with each of the two or more second reactors (200-1 and 200-2) in the RGM mode via the corresponding second gas inlet (1502 and 1504).

In some embodiments, the two or more second reactors (200-1 and 200-2) in the RGM mode are heated during regeneration of the catalyst and the N₂ selective adsorbent in the two or more second fixed adsorbent and catalyst beds (202-1 and 202-2), thereby releasing the N₂ from the N₂-containing adsorbent and the NH₃ from the spent catalyst. In some embodiments, the two or more second reactors (200-1 and 200-2) in the RGM mode are pressurized during regeneration of the catalyst and the N₂ selective adsorbent in the second fixed adsorbent and catalyst bed (202-1 and 202-2), thereby releasing the N₂ from the N₂-containing adsorbent and the NH₃ from the spent catalyst.

In some embodiments the foremost second gas outlet (1602) of the second reactor (200-1) in the RGM mode is in fluid communication with a second polisher (600) via the plurality of throttling valves (300-9, 300-10, and 300-11). In some embodiments the last second gas outlet (1604) of the second reactor (200-2) in the RGM mode is in fluid communication with a second polisher (600) via the plurality of throttling valves (300-10 and 300-11). In some embodiments, a N₂-containing product gas stream (2200) containing a first N₂-containing product gas stream (2202) and a second N₂-containing product gas stream (2204) originated from the two or more second reactors (200-1 and 200-2), respectively.

In some embodiments, the N₂-containing adsorbent of the second fixed adsorbent and catalyst bed (202-1 and 202-2) after the regeneration has an average particle size ranging from about 100 nm to about 10 μm, such as about 200 nm to about 8 μm, about 400 nm to about 6 μm, about 600 nm to about 4 μm, about 800 nm to about 2 pam, or about 1 μm to about 1.5 pam, or about 100 nm, about 300 nm, about 500 nm, about 700 nm, about 900 nm, about 1.1 μm, about 1.5 μm, about 2 μm, about 2.5 μm, about 3 μm, about 3.5 μm, about 4 μm, about 4.5 μm, or about 5 μm.

In some embodiments, the N₂-containing adsorbent of the second fixed adsorbent and catalyst bed (202-1 and 202-2) after the regeneration has a surface area of about 600 to about 4500 m²/g, such as about 800 to about 4300 m²/g, about 1000 to about 4100 m²/g, about 1200 to about 3900 m²/g, about 1400 to about 3700 m²/g, about 1600 to about 3500 m²/g, about 1800 to about 3300 m²/g, about 2000 to about 3100 m²/g, about 2200 to about 2900 m²/g, about 2400 to about 2700 m²/g, or about 2500 to about 2600 m²/g, or about 600 m²/g, about 900 m²/g, about 1200 m²/g, about 1500 m²/g, about 1800 m²/g, about 2100 m²/g, about 2400 m²/g, about 2700 m²/g, about 3000 m²/g, about 3300 m²/g, about 3600 m²/g, about 3900 m²/g, about 4200 m²/g, or about 4500 m²/g.

Nitrogen is passed through the reactors in the regeneration mode where the adsorbent in the reactor is regenerated via a temperature swing process or a pressure swing process. The adsorbed nitrogen is desorbed by changing the reactor temperature or pressure based upon the characteristics of the adsorbent. In an example, the reactor pressure is varied in a pressure swing adsorption process for nitrogen desorption. In an example, the reactor temperature is varied in a temperature swing adsorption process.

In some embodiments, the N₂-containing product gas stream (2200) contains N₂ and NH₃. The N₂-containing product gas stream (2200) is introduced into the second polisher (600) to separate residue NH₃ from the N₂-containing product gas stream (2200) originated from a foremost second and last second gas outlets (1602 and 1604), thereby generating a second polished product gas stream (2600) containing NH₃. In some embodiments, the second polished product gas stream (2600) is introduced into the ammonia source (1200) via one of the plurality of throttling valves (300-12). In further embodiments, the N₂-containing product gas stream (2200) may bypass the polisher when the residue NH₃ is less than about 0.5 wt. %, such as less than about 0.4 wt. %, less than about 0.3 wt. %, less than about 0.2 wt. %, less than about 0.1 wt. %, less than about 0.05 wt. %, less than about 0.01 wt. %, or less than about 0.001 wt. % of a total weight of the N₂-containing product gas stream (2200). In such cases, the N₂-containing product gas stream (2200) is released from the system 1000 as a nitrogen stream (2300). In some embodiments, the second polisher (600) is a water-based ammonia absorber or a pressure swing adsorption (PSA) based ammonia adsorber. In further embodiments, the first polisher (600) is a PSA based ammonia adsorber. In some embodiments, the second polisher (600) is in fluid communication with a second SEP (700).

The system 1000 further includes a purge stream (2700) via one of the plurality of throttling valves (300-8) to remove contaminants or moistures from the system 1000.

In some embodiments, the two or more first reactors (100-1 and 100-2) in the RM mode and the two or more second reactors (200-1 and 200-2) in the RGM mode are sequentially operable and positioned in parallel. In some embodiments, the two or more first reactors (100-1 and 100-2) in the RM mode are configured to simultaneously in-situ decompose NH₃ and selectively adsorb N₂ in the first fixed adsorbent and catalyst bed (102-1 and 102-2). In some embodiments, the two or more second reactors (200-1 and 200-2) in the RGM mode are configured to continuously regenerate the catalyst from the spent catalyst and the N₂ selective adsorbent from the N₂-containing adsorbent in the second fixed adsorbent and catalyst bed (202-1 and 202-2).

In some embodiments, the two or more first reactors (100-1 and 100-2) in the RM mode are changed to the RGM mode after the decomposing the NH₃. In some embodiments, the two or more second reactors (200-1 and 200-2) in the RGM mode are changed to the RM mode at a substantially same time when the two or more first reactors (100-1 and 100-2) in the RM mode are changed to the RGM mode. In some embodiments, the adsorbent in the first fixed adsorbent and catalyst bed (102-1 and 102-2) is saturated with N₂ at a substantially same time as the regeneration of the adsorbent in the second fixed adsorbent and catalyst bed (202-1 and 202-2).

FIG. 2 illustrates a second step of the fixed adsorbent and catalyst bed containing system 1000 for NH₃ decomposition, in which the two or more first reactors (100-1 and 100-2) in the RM mode are changed to the RGM mode, and the two or more second reactors (200-1 and 200-2) in the RGM mode are changed to the RM mode.

In some embodiments, the two or more second reactors (200-1 and 200-2) share a same ammonia source (1200). In some embodiments, the ammonia source (1200) is split into two or more ammonia feed streams (1206 and 1208) via two or more throttling valves (300-3 and 300-4). In some embodiments, the ammonia source (1200) is in fluid communication with each of the two or more second reactors (200-1 and 200-2) via the corresponding second gas inlet (1502 and 1504).

In some embodiments, the foremost second gas outlet (1602) of the foremost second reactor (200-1) in the RM mode is in fluid communication with the second polisher (600) via the plurality of throttling valves (300-9, 300-10, and 300-11). In some embodiments, the last second gas outlet (1604) of the last second reactor (200-2) in the RM mode is in fluid communication with the second polisher (600) via at least one of the plurality of throttling valves (300-10 and 300-11). In some embodiments, the product gas stream (2200) includes a foremost second product gas stream (2202) and a last second product gas stream (2204) originated from the two or more second reactors (200-1 and 200-2), respectively.

In some embodiments, the second polisher (600) separates unreacted NH₃ from the product gas stream (2200) originated from the foremost second and last second gas outlets (1602 and 1604), thereby generating a second NH₃ recycle stream (2600) and a second polished product gas stream (2500) containing H₂ and N₂. In some embodiments, the second polished product gas stream (2500) is introduced into a second SEP (700) to separate H₂ and N₂, thereby generating a H₂-containing gas stream (2000) and a first N₂-containing gas stream (2100). In some embodiments, the second polisher (600) is a water-based ammonia absorber or a pressure swing adsorption (PSA) based ammonia adsorber. In further embodiments, the second polisher (600) is a PSA based ammonia adsorber. In some embodiments, the second SEP (700) is a PSA-based selective nitrogen adsorber or a PSA-based selective hydrogen adsorber. In some embodiments, the second NH₃ recycle stream (2600) is configured to flow into the ammonia source (1200) via a throttling valve (300-12).

Also, referring to FIG. 2, the two or more first reactors (100-1 and 100-2) of the system 1000 in the second step are in the RGM mode. In some embodiments, the foremost first fixed adsorbent and catalyst bed (102-1) and the last first fixed adsorbent and catalyst bed (102-2) contain the catalyst after the decomposing the NH₃ and the N₂ selective adsorbent after the adsorbing the N₂ from the step one of the system 1000.

In some embodiments, the two or more first reactors (100-1 and 100-2) in the RGM mode share a same nitrogen source (1100). The nitrogen source (1100) is split into two or more nitrogen feed streams (1102 and 1104) via two or more throttling valves (300-1 and 300-2). In some embodiments, the nitrogen source (1100) is in fluid communication with each of the two or more first reactors (100-1 and 100-2) in the RGM mode via the corresponding first gas inlet (1302 and 1304).

In some embodiments, the two or more first reactors (100-1 and 100-2) in the RGM mode are heated during the regeneration of the catalyst and adsorbent in the two or more first fixed adsorbent and catalyst beds (102-1 and 102-2), thereby releasing the N₂ from the adsorbent and the NH₃ from the catalyst. In some embodiments, the two or more first reactors (200-1 and 200-2) in the RGM mode are pressurized during regeneration of the catalyst and adsorbent in the first fixed adsorbent and catalyst bed (102-1 and 102-2), thereby releasing the N₂ from the adsorbent and the NH₃ from the catalyst.

In some embodiments, the foremost first gas outlet (1402) of the first reactor (100-1) in the RGM mode is in fluid communication with the first polisher (400) via at least one of the plurality of throttling valves (300-5 and 300-13). In some embodiments, the last first gas outlet (1404) of the first reactor (100-2) in the RGM mode is in fluid communication with the first polisher (400) via the plurality of throttling valves (300-5, 300-6, and 300-13). In some embodiments, a N₂-containing product gas stream (1700) containing a first N₂-containing product gas stream (1702) and a second N₂-containing product gas stream (1704) originates from the two or more first reactors (100-1 and 100-2), respectively.

In some embodiments, the adsorbent of the foremost first and last first fixed adsorbent and catalyst bed (102-1 and 102-2) after the regeneration has an average particle size ranging from about 100 nm to about 10 μm, such as about 200 nm to about 8 μm, about 400 nm to about 6 μm, about 600 nm to about 4 μm, about 800 nm to about 2 μm, or about 1 μm to about 1.5 μm, or about 100 nm, about 300 nm, about 500 nm, about 700 nm, about 900 nm, about 1.1 μm, about 1.5 μm, about 2 μm, about 2.5 μm, about 3 μm, about 3.5 μm, about 4 μm, about 4.5 μm, or about 5 μm.

In some embodiments, the adsorbent of the foremost first and last first fixed adsorbent and catalyst bed (102-1 and 102-2) after the regeneration has a surface area of about 600 to about 4500 m²/g, such as about 800 to about 4300 m²/g, about 1000 to about 4100 m²/g, about 1200 to about 3900 m²/g, about 1400 to about 3700 m²/g, about 1600 to about 3500 m²/g, about 1800 to about 3300 m²/g, about 2000 to about 3100 m²/g, about 2200 to about 2900 m²/g, about 2400 to about 2700 m²/g, or about 2500 to about 2600 m²/g, or about 600 m²/g, about 900 m²/g, about 1200 m²/g, about 1500 m²/g, about 1800 m²/g, about 2100 m²/g, about 2400 m²/g, about 2700 m²/g, about 3000 m²/g, about 3300 m²/g, about 3600 m²/g, about 3900 m²/g, about 4200 m²/g, or about 4500 m²/g.

Nitrogen is passed through the reactors in the regeneration mode where the adsorbent in the reactor is regenerated via temperature swing or pressure swing process. The adsorbed nitrogen is desorbed by changing the reactor temperature or pressure based upon the characteristics of the adsorbent. In an example, the reactor pressure is varied in a pressure swing adsorption process for nitrogen desorption. In an example, the reactor temperature is varied in a temperature swing adsorption process.

In some embodiments, the N₂-containing product gas stream (1700) contains N₂ and NH₃. The N₂-containing product gas stream (1700) is introduced into the first polisher (400) to separate residue NH₃ from the N₂-containing product gas stream (1700) originated from a foremost first and last first gas outlets (1402 and 1404), thereby generating a first polished product gas stream (1900) containing NH₃. In some embodiments, the first polished product gas stream (1900) is introduced into the ammonia source (1200) via one of the plurality of throttling valves (300-7). In further embodiments, the N₂-containing product gas stream (1700) bypasses the polisher when the residue NH₃ is less than about 0.5 wt. %, such as less than about 0.4 wt. %, less than about 0.3 wt. %, less than about 0.2 wt. %, less than about 0.1 wt. %, less than about 0.05 wt. %, less than about 0.01 wt. %, or less than about 0.001 wt. % of a total weight of the N₂-containing product gas stream (1700). In such cases, the N₂-containing product gas stream (1700) is released from the system 1000 as the nitrogen stream (2300). In some embodiments, the first polisher (400) is a water-based ammonia absorber or a pressure swing adsorption (PSA) based ammonia adsorber. In further embodiments, the first polisher (400) is a PSA based ammonia adsorber. In some embodiments, the first polisher (400) is in fluid communication with the first SEP (500).

Also provided is a method for decomposing ammonia (NH₃) to nitrogen (N₂) and hydrogen (H₂). In further embodiments, the method for decomposing NH₃ to N₂ and H₂ is performed using the system 1000. The method includes splitting and introducing an NH₃-containing feed gas stream into two of more first reactors in a reaction (RM) mode via a first gas inlet. In some embodiments, each of the two of more first reactors in the RM mode includes the first gas inlet, a first gas outlet, and a first fixed adsorbent and catalyst bed containing a catalyst for decomposing NH₃ to a gas mixture containing N₂ and H₂, and a N₂ selective adsorbent for in-situ adsorbing N₂ from the gas mixture.

The method further includes contacting the NH₃-containing feed gas with the catalyst and adsorbent disposed in the first fixed adsorbent and catalyst bed to form a first N₂-containing adsorbent and a product gas stream leaving the first reactor in the RM mode via the first gas outlet.

The method further includes at substantially the same time of splitting and introducing the NH₃-containing feed gas stream into the two or more first reactors in the RM mode, splitting and introducing a N₂-containing feed gas stream into two or more second reactors in the regeneration mode (RGM) via a second gas inlet. In some embodiments, the two or more second reactors in the RGM mode include the second gas inlet, a second gas outlet, and a second fixed adsorbent and catalyst bed containing an NH₃-containing spent catalyst and a second N₂-containing adsorbent. In some embodiments the second N₂-containing adsorbent has substantially the same structure and composition as the first N₂-containing adsorbent. In some embodiments, the NH₃-containing spent catalyst has the same structure and composition as the catalyst from the two or more first reactors after decomposing the NH₃.

The method further includes heating or pressurizing the second fixed adsorbent and catalyst bed to release the N₂ from the second N₂-containing adsorbent and the NH₃ from the NH₃-containing spent catalyst, thereby regenerating the N₂ selective adsorbent and the catalyst. In some embodiments, the second fixed adsorbent and catalyst bed is heated at a temperature of about 40 to about 500° C., such as about 60 to about 450° C., about 80 to about 400° C., about 100 to about 350° C., about 120 to about 300° C., about 140 to about 250° C., or about 160 to about 200° C., or about 40° C., about 80° C., about 120° C., about 160° C., about 200° C., about 240° C., about 280° C., about 320° C., about 360° C., about 400° C., about 440° C., or about 480° C. In some embodiments, the second fixed adsorbent and catalyst bed is pressurized at a pressure of about 1 to about 1,000 bar, such as about 5 to about 900 bar, about 10 to about 800 bar, about 15 to about 700 bar, about 20 to about 600 bar, about 25 to about 500 bar, about 30 to about 400 bar, about 35 to about 300 bar, about 40 to about 200 bar, about 45 to about 100 bar, about 50 to about 90 bar, about 55 to about 80 bar, or about 60 to about 70 bar, or about 1 bar, about 10 bar, about 50 bar, about 100 bar, about 150 bar, about 200 bar, about 300 bar, about 400 bar, about 500 bar, about 600 bar, about 700 bar, about 800 bar, or about 900 bar.

The method further includes changing the two or more first reactors to the RGM mode after decomposing the NH₃, and the two or more second reactors to the RM mode at substantially the same time. In some embodiments, the two or more first reactors and the two or more second reactors are sequentially operable and positioned in parallel.

The method further includes introducing the product gas stream from the two or more first reactors in the RM mode to a first polisher via one of the plurality of throttling valves. In some embodiments, the first polisher is configured to separate unreacted NH₃ from the product gas stream and form a first polished product gas stream containing H₂ and N₂.

The method further includes introducing the first polished product gas stream into a first separator (SEP) to separate H₂ and N₂, thereby generating a H₂-containing gas stream and a first N₂-containing gas stream. In some embodiments, the H₂ and N₂ are separated by techniques including, but not limited to, temperature swing adsorption, pressure swing adsorption (PSA), membrane separation, cryogenic distillation, chemical reactions.

In some embodiments, the separating is performed by introducing the first polished product gas stream into a hydrogen purification device including one or more hydrogen-selective membranes. The hydrogen purification device is configured to separate hydrogen from the residue gas stream and purifying the same. The hydrogen purification device may be a palladium membrane hydrogen purifier. The palladium membrane includes, but is not limited to, metallic tubes of palladium and silver alloy for allowing only monatomic hydrogen to pass through its crystal lattice when it is heated above about 300° C. The hydrogen-selective membranes are permeable to hydrogen gas but are at least substantially impermeable to other components in the residue gas stream. The plurality of hydrogen-selective membranes in the hydrogen purification device is arranged in parallel, and each membrane of the plurality of hydrogen-selective membranes is placed in a plane perpendicular to a direction of the gas mixture flow in the hydrogen purification device. The method for decomposing NH₃ may further include passing the first polished product gas stream through the plurality of hydrogen-selective membranes in the hydrogen purification device thereby allowing hydrogen gas to pass through the hydrogen-selective membrane and rejecting other components in the residue gas stream to form a residue composition. The method for decomposing NH₃ may further include collecting the hydrogen gas after passing to form the H₂-containing gas stream and recycling the residue composition to form the first N₂-containing gas stream.

In some embodiments, the separating is performed by introducing the first polished product gas stream into a nitrogen purification device including one or more nitrogen-selective membranes. The nitrogen purification device is configured to separate nitrogen from the residue gas stream and purifying the same. The nitrogen purification device may be a vanadium membrane nitrogen purifier. The nitrogen-selective membranes are permeable to nitrogen gas but are at least substantially impermeable to other components in the residue gas stream. The plurality of nitrogen-selective membranes in the nitrogen purification device is arranged in parallel, and each membrane of the plurality of nitrogen-selective membranes is placed in a plane perpendicular to a direction of the gas mixture flow in the nitrogen purification device. The method for decomposing NH₃ may further include passing the first polished product gas stream through the plurality of nitrogen-selective membranes in the nitrogen purification device thereby allowing nitrogen gas to pass through the nitrogen-selective membrane and rejecting other components in the residue gas stream to form a residue composition. The method for decomposing NH₃ may further include collecting the nitrogen gas after passing to form the first N₂-containing gas stream and recycling the residue composition to form the H₂-containing gas stream.

The method further includes introducing the first N₂-containing gas stream into the two or more second reactors in the RGM mode via the second gas inlet.

The method further includes combining the first N₂-containing gas stream, the N₂ released from the second N₂-containing adsorbent, and the NH₃ released from the NH₃-containing spent catalyst to form a N₂-containing product gas stream leaving the second reactor via the second gas outlet.

The method further includes introducing the N₂-containing product gas stream into a second polisher via one of the plurality of throttling valves. In some embodiments, the second polisher is configured to separate NH₃ from the N₂-containing product gas stream.

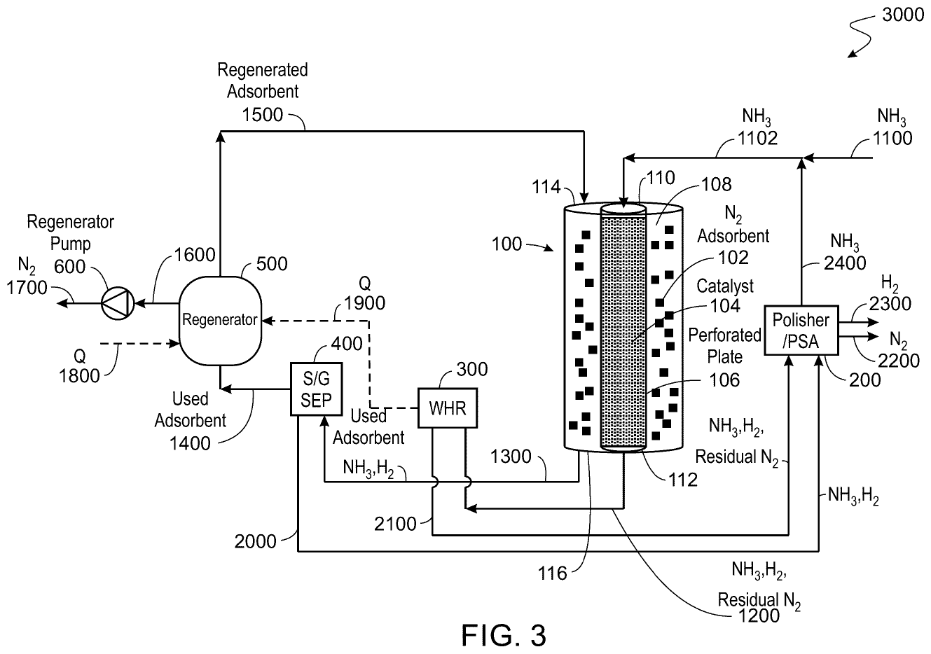

Also provided in the present disclosure is a moving adsorbent bed and fixed catalyst bed containing system 3000, as depicted in FIG. 3. In some embodiments, the system 3000 includes a reactor (100) in the form of a cylinder having a central longitudinal axis. In some embodiments, the reactor (100) includes a perforated cylindrical tube (106) at the center of the reactor (100) extending along the central longitudinal axis and a cavity (108) formed between an outer side wall of the perforated cylindrical tube (106) and an inner side wall of the reactor (100). In some embodiments, the reactor (100) includes an ammonia (NH₃) gas inlet (110) disposed at an uppermost point of the perforated cylindrical tube (106). In some embodiments, the reactor (100) includes a product gas stream outlet (112) disposed at the bottommost point of the perforated cylindrical tube (106). In some embodiments, the reactor (100) includes an adsorbent inlet (114) at the uppermost point of the cavity (108). In some embodiments, the reactor (100) includes an adsorbent outlet (116) at the bottommost point of the cavity (108).

In some embodiments, the NH₃ decomposition catalyst (104) is uniformly distributed throughout the perforated cylindrical tube (106), thereby forming the fixed catalyst bed.

In some embodiments, an adsorbent (102) is uniformly distributed throughout the cavity (108), thereby forming the moving adsorbent bed. In some embodiments, the mean particle size of the adsorbent (102) is at least about 5% larger than an average hole size of the perforated cylindrical tube (106), such as at least about 10% larger, at least about 15% larger, at least about 20% larger, at least about 25% larger, at least about 30% larger, at least about 35% larger, at least about 40% larger, at least about 45% larger, at least about 50% larger, at least about 60% larger, at least about 70% larger, at least about 80% larger, at least about 90% larger, or at least about 100% larger than an average hole size of the perforated cylindrical tube (106).

In some embodiments, a NH₃ source (1100) is in fluid communication with the reactor (100) via an NH₃-containing gas stream (1102). The NH₃-containing gas stream (1102) is introduced into the reactor (100) via the NH₃ gas inlet (110). The NH₃-containing gas stream (1102) is in contact with the fixed catalyst bed containing the NH₃ decomposition catalyst (104), thereby at least partially decomposing the NH₃ present in the NH₃-containing gas stream (1102) into N₂ and H₂, and generating a product gas stream (1200) containing NH₃, N₂, and H₂ leaving the reactor (100) via the product gas stream outlet (112), and a N₂-containing adsorbent stream (1300) containing the N₂-containing adsorbent leaving the reactor (100). In some embodiments, the N₂ generated from the decomposing of the NH₃ is at least partially passed through voids of the perforated cylindrical tube (106), and is adsorbed by the adsorbent (102) present in the cavity (108), thereby forming the N₂-containing adsorbent. In some embodiments, the adsorbent (102) is a N₂ selective adsorbent that only adsorbs N₂ molecules, thereby at least partially separating the N₂ from the product gas stream (1200). An enhanced reaction rate for ammonia decomposition as well as an increased ammonia conversion are achieved due to the in-situ separation of the reaction product, i.e., N₂. The perforated plate avoids the mixing of the catalyst (104) and the adsorbent (102), resulting in a decrease in the concentration of the reaction product, i.e., N₂, thus leading to an enhanced reaction rate according to the Le Chatelier's principle.

Also, referring to FIG. 3, the system 3000 further includes a waste heat recovery unit (WHR) (300), a separator (SEP) (400), a regenerator (500), a regenerator pump (600), and a polisher (200). In some embodiments, the SEP (400) is a gas/solid separator (S/G SEP). In some embodiments, the reactor (100) is in fluid communication with the WHR (300) via the product gas stream outlet (112). In some embodiments, the WHR (300) is in fluid communication with the polisher (200). In some embodiments, the reactor is in mass and fluid communications with the SEP (400) via the adsorbent outlet (116). In some embodiments, the SEP (400) is in fluid communication with the polisher (200). In some embodiments, the SEP (400) is in mass communication with the regenerator (500). In some embodiments, the regenerator (500) is in mass communication with the cavity (108) of the reactor (100) via the adsorbent inlet (114).

In some embodiments, the adsorbent (102) after adsorbing the N₂ (referred to herein as the N₂-containing adsorbent) is introduced into the SEP (400) configured to separate the N₂-containing adsorbent in a solid form from unreacted ammonia and produced hydrogen from the product gas stream (1200), thereby generating a recycle gas stream (2000) and a recycle solid stream (1400). The SEP (400), e.g., a gas/solid separator (S/G SEP), is in fluid communication with the polisher (200) via the recycle gas stream (2000) containing NH₃ and H₂. The polisher (200) separates the NH₃ and H₂ present in the recycle gas stream (2000), thereby generating a H₂-containing gas stream (2300) and a first NH₃-containing gas stream (2400). In some embodiments, the first NH₃-containing gas stream (2400) is introduced into the ammonia source (1100), or configured to combine with the NH₃-containing gas stream (1102) and enter the reactor (100).

In some embodiments, the recycle solid stream (1400) containing the N₂-containing adsorbent is introduced into the regenerator (500) configured to separate the N₂ from the N₂-containing adsorbent, thereby regenerating the adsorbent (102) to form a regenerated adsorbent stream (1500) and a N₂-containing stream (1600). The regenerated adsorbent stream (1500) containing the adsorbent (102) from the regenerating is introduced into the cavity (108) of the reactor (100) via the adsorbent inlet (114). In some embodiments, the N₂-containing stream (1600) is introduced into the regenerator pump (600) configured to enhance N₂ removal from the regenerator (500), thereby forming a N₂ gas (1700).

In some embodiments, the product gas stream (1200) is introduced into the WHR (300) configured to recover heat from the product gas stream (1200), thereby generating a first waste heat stream (1800) and a second waste heat stream (1900). In some embodiments, the WHR is in thermal communication with the first regenerator via the first waste heat stream (1800) and the second waste heat stream (1900). In some embodiments, the first waste heat stream (1800) is in thermal communication with a bottom portion of the regenerator (500) and is used to provide heat. In some embodiments, the second waste heat stream (1900) is in thermal communication with a middle portion of the regenerator (500) and is also used to provide heat. In some embodiments, the product gas stream (1200) after passing through the WHR (300) is introduced into the polisher (200) to separate the NH₃, H₂, and residual N₂ present in the product gas stream (1200), thereby generating the H₂-containing gas stream (2300), the first NH₃-containing gas stream (2400), and a first N₂-containing gas stream (2200). In some embodiments, the first N₂-containing gas stream (2200) is configured to flow into the N₂-containing stream (1600) from the regenerator (500).

Also, referring to FIG. 3, in some embodiments, the polisher (200) is a water-based ammonia absorber or a pressure swing adsorption (PSA) based ammonia adsorber. In further embodiments, the polisher (200) is a PSA based ammonia adsorber. In some embodiments, the SEP (400) is a solid-gas separator that separates the used solid adsorbent from the gases in the stream.

Also provided herein is a method for decomposing ammonia NH₃ to N₂ and H₂. In further embodiments, the method for decomposing NH₃ to N₂ and H₂ is performed using the system 3000. The method includes introducing an NH₃-containing gas stream into the reactor of the system 3000 via the NH₃ gas inlet. The method further includes contacting the NH₃-containing gas stream with the NH₃ decomposition catalyst disposed on the fixed catalyst bed, thereby generating nitrogen (N₂) and hydrogen (H₂). The method further includes collecting N₂ and H₂, respectively.

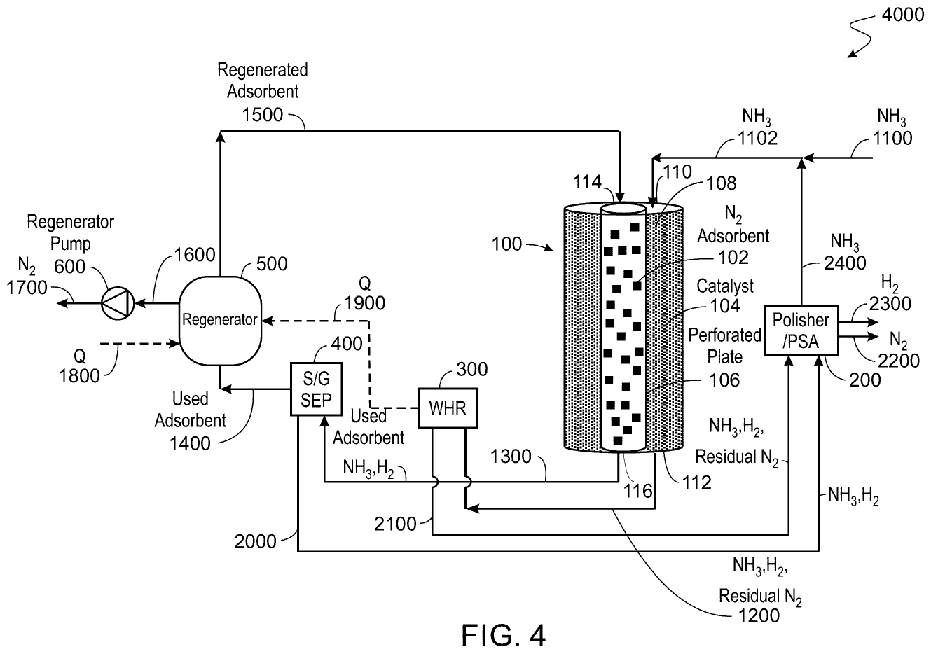

Also provided in the present disclosure is a moving adsorbent bed and fixed catalyst bed containing system 4000, as depicted in FIG. 4. In some embodiments, the system 4000 includes a reactor (100) in the form of a cylinder having a central longitudinal axis. In some embodiments, the reactor (100) includes a perforated cylindrical tube (106) at the center of the reactor (100) extending along the central longitudinal axis and a cavity (108) formed between an outer side wall of the perforated cylindrical tube (106) and an inner side wall of the reactor (100). In some embodiments, the reactor (100) includes an ammonia (NH₃) gas inlet (110) disposed at an uppermost point of the cavity (108). In some embodiments, the reactor (100) includes a product gas stream outlet (112) disposed at the bottommost point of the cavity (108). In some embodiments, the reactor (100) includes an adsorbent inlet (114) at the uppermost point of the perforated cylindrical tube (106). In some embodiments, the reactor (100) includes an adsorbent outlet (116) at the bottommost point of the perforated cylindrical tube (106).

In some embodiments, the NH₃ decomposition catalyst (104) is uniformly distributed throughout the cavity (108), thereby forming the fixed catalyst bed.

In some embodiments, an adsorbent (102) is uniformly distributed throughout the cavity (108), thereby forming the moving adsorbent bed. In some embodiments, the mean particle size of the adsorbent (102) is at least about 5% larger than an average hole size of the perforated cylindrical tube (106), such as at least about 10% larger, at least about 15% larger, at least about 20% larger, at least about 25% larger, at least about 30% larger, at least about 35% larger, at least about 40% larger, at least about 45% larger, at least about 50% larger, at least about 60% larger, at least about 70% larger, at least about 80% larger, at least about 90% larger, or at least about 100% larger than an average hole size of the perforated cylindrical tube (106).

In some embodiments, a NH₃ source (1100) is in fluid communication with the reactor (100) via an NH₃-containing gas stream (1102). The NH₃-containing gas stream (1102) is introduced into the reactor (100) via the NH₃ gas inlet (110). The NH₃-containing gas stream (1102) is in contact with the fixed catalyst bed containing the NH₃ decomposition catalyst (104), thereby at least partially decomposing the NH₃ present in the NH₃-containing gas stream (1102) into N₂ and H₂, and generating a product gas stream (1200) containing NH₃, N₂, and H₂ leaving the reactor (100) via the product gas stream outlet (112), and a N₂-containing adsorbent stream (1300) containing the N₂-containing adsorbent leaving the reactor (100) via the adsorbent outlet (116). In some embodiments, the N₂ generated from decomposing the NH₃ is at least partially passed through voids of the perforated cylindrical tube (106), and is adsorbed by the adsorbent (102) present in the perforated cylindrical tube (106), thereby forming the N₂-containing adsorbent. In some embodiments, the adsorbent (102) is a N₂ selective adsorbent that only adsorbs N₂ molecules, thereby at least partially separating the N₂ from the product gas stream (1200). An enhanced reaction rate for ammonia decomposition as well as an increased ammonia conversion are achieved due to the in-situ separation of the reaction product, e.g., N₂. The perforated plate avoids the mixing of the catalyst (104) and the adsorbent (102), resulting in a decrease in the concentration of the reaction product, e.g., N₂, thus leading to an enhanced reaction rate according to the Le Chatelier's principle.

Also, referring to FIG. 4, the system 4000 further includes a waste heat recovery unit (WHR) (300), a separator (SEP) (400), a regenerator (500), a regenerator pump (600), and a polisher (200). In some embodiments, the SEP (400) is a gas/solid separator (S/G SEP). In some embodiments, the reactor (100) is in fluid communication with the WHR (300) via the product gas stream outlet (112). In some embodiments, the WHR (300) is in fluid communication with the polisher (200). In some embodiments, the reactor is in mass and fluid communications with the SEP (400) via the adsorbent outlet (116). In some embodiments, the SEP (400) is in fluid communication with the polisher (200). In some embodiments, the SEP (400) is in mass communication with the regenerator (500). In some embodiments, the regenerator (500) is in mass communication with the perforated cylindrical tube (106) of the reactor (100) via the adsorbent inlet (114).

In some embodiments, the adsorbent (102) after adsorbing the N₂ (referred to herein as the N₂-containing adsorbent) is introduced into the SEP (400) configured to separate the N₂-containing adsorbent in a solid form from un-reacted ammonia and produced hydrogen from the product gas stream (1200), thereby generating a recycle gas stream (2000) and a recycle solid stream (1400). The SEP (400), e.g., a gas/solid separator (S/G SEP), is in fluid communication with the polisher (200) via the recycle gas stream (2000) containing NH₃ and H₂. The polisher (200) separates the NH₃ and H₂ present in the recycle gas stream (2000), thereby generating a H₂-containing gas stream (2300) and a first NH₃-containing gas stream (2400). In some embodiments, the first NH₃-containing gas stream (2400) is introduced into the ammonia source (1100), or configured to combine with the NH₃-containing gas stream (1102) and enter the reactor (100).

In some embodiments, the recycle solid stream (1400) containing the N₂-containing adsorbent is introduced into the regenerator (500) configured to separate the N₂ from the N₂-containing adsorbent, thereby regenerating the adsorbent (102) to form a regenerated adsorbent stream (1500) and a N₂-containing stream (1600). The regenerated adsorbent stream (1500) containing the adsorbent (102) from the regenerating is introduced into the perforated cylindrical tube (106) of the reactor (100) via the adsorbent inlet (114). In some embodiments, the N₂-containing stream (1600) is introduced into the regenerator pump (600) configured to enhance N₂ removal from the regenerator (500), thereby forming a N₂ gas (1700).

In some embodiments, the product gas stream (1200) is introduced into the WHR (300) configured to recover heat from the product gas stream (1200), thereby generating a first waste heat stream (1800) and a second waste heat stream (1900). In some embodiments, the WHR is in thermal communication with the first regenerator via the first waste heat stream (1800) and the second waste heat stream (1900). In some embodiments, the first waste heat stream (1800) in thermal communication with a bottom portion of the first regenerator (500) and is used to provide heat. In some embodiments, the second waste heat stream (1900) in thermal communication with a middle portion of the regenerator (500) and is also used to provide heat. In some embodiments, the product gas stream (1200) after passing through the WHR (300) is introduced into the polisher (200) to separate the NH₃, H₂, and residual N₂ present in the product gas stream (1200), thereby generating the H₂-containing gas stream (2300), the first NH₃-containing gas stream (2400), and a first N₂-containing gas stream (2200). In some embodiments, the first N₂-containing gas stream (2200) is configured to flow into the N₂-containing stream (1600) from the regenerator (500).

Also, referring to FIG. 4, in some embodiments, the polisher (200) is a water-based ammonia absorber or a pressure swing adsorption (PSA) based ammonia adsorber. In further embodiments, the polisher (200) is a PSA based ammonia adsorber. In some embodiments, the SEP (400) is a solid-gas separator configured to use centrifugal force to separate a solid from a solid-gas mixture, thereby resulting in a gas leaving the separator. In further embodiments, the SEP (400) is a cyclone type-based solid-gas separator. In some embodiments, the SEP (400) is a settling chamber-type separator configured to separate a solid from a solid-gas mixture by gravity, thereby resulting in a gas leaving the separator. The solid-gas mixture may enter a large chamber at low velocities, causing the solids to settle at the bottom of the chamber due to gravity.

Also provided is a method for decomposing ammonia NH₃ to N₂ and H₂. In some embodiments, the method for decomposing NH₃ to N₂ and H₂ is performed using the system 4000. The method includes introducing an NH₃-containing gas stream into the reactor of the system 4000 via the NH₃ gas inlet. The method further includes contacting the NH₃-containing gas stream with the NH₃ decomposition catalyst disposed on the fixed catalyst bed, thereby generating nitrogen (N₂) and hydrogen (H₂). The method further includes collecting N₂ and H₂, respectively.

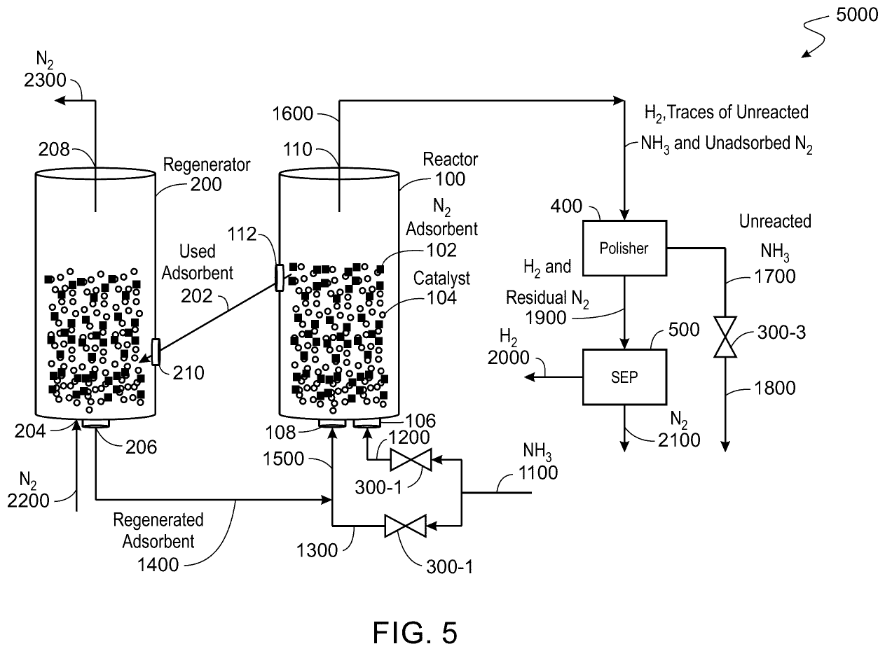

Also provided in the present disclosure is a dual fluidized bed containing system 5000, as depicted in FIG. 5. In some embodiments, the system 5000 includes a first fluidized bed reactor (100) in the form of a cylinder having a first ammonia (NH₃) gas inlet (106) disposed at a first bottom point of the first fluidized bed reactor (100), a second inlet (108) disposed at a second bottom point of the first fluidized bed reactor (100), a product gas stream outlet (110) disposed at a top point of the first fluidized bed reactor (100), a solid product outlet (112) disposed on an outer side wall of an upper body portion of the first fluidized bed reactor (100), an adsorbent (102), and a catalyst (104).

Also, referring to FIG. 5, the system 5000 includes a second fluidized bed reactor (200) in the form of a cylinder having a first N₂ gas inlet (204) disposed at a first bottom point of the second fluidized bed reactor (100), a regenerated solid product outlet (206) disposed at a second bottom point of the second fluidized bed reactor (100), a N₂ gas outlet (208) disposed at a first top point of the second fluidized bed reactor (100), and a solid product inlet (210) disposed on an outer side wall of a lower body portion of the second fluidized bed reactor (100).

In some embodiments, the first fluidized bed reactor (100) and the second fluidized bed reactor (200) are positioned parallel to each other in the same horizontal plane. In some embodiments, the solid product outlet (112) of the first fluidized bed reactor (100) is located at a position higher than the solid product inlet (210) of the second fluidized bed reactor (200) relative to the same horizontal plane of the first fluidized reactor (100) and the second fluidized reactor (200). In some embodiments, the adsorbent and the catalyst are homogenously distributed thorough the first fluidized bed reactor.

Also, referring to FIG. 5, the system 5000 further includes a polisher (400), a separator (SEP) (500), and a plurality of throttling valves (300-1, 300-2, and 300-3).

In some embodiments, an ammonia source is in fluid communication with the first fluidized bed reactor (100) via the first and second throttling valves (300-1, and 300-2). In some embodiments, an NH₃-containing gas stream (1100) from the ammonia source is split into a first NH₃-containing stream (1200) and a second NH₃-containing stream (1300). The first NH₃-containing stream (1200) is introduced into the first fluidized bed reactor (100) containing the adsorbent (102) and the catalyst (104) via the first NH₃ gas inlet (106). The first NH₃-containing stream (1200) is in contact with the adsorbent (102) and the catalyst (104), thereby at least partially decomposing the NH₃ present in the first NH₃-containing gas stream (1200) into N₂ and H₂, and generating a product gas stream (1600) containing NH₃, N₂, and H₂ leaving the reactor (100) via the product gas stream outlet (110), and a N₂-containing adsorbent. In some embodiments, the adsorbent (102) is a N₂ selective adsorbent that only adsorbs N₂ molecules, thereby at least partially separating the N₂ from the product gas stream (1600). An enhanced reaction rate for ammonia decomposition as well as an increased ammonia conversion are achieved due to the in-situ separation of the reaction product, e.g., N₂. The adsorption of N₂ by a mixture of the catalyst (104) and the adsorbent (102) present in the fluidized reactor (100) results in a decrease in the concentration of the N₂ in the reaction product stream, thus leading to an enhanced reaction rate according to the Le Chatelier's principle.

In some embodiments, the product gas stream (1600) is introduced into the polisher (400) configured to separate unreacted NH₃ from the product gas stream (1600), thereby generating an NH₃ recycle stream (1700) and a polished product gas stream (1900) containing H₂ and N₂. In some embodiments, the polished product gas stream (1900) is introduced into the SEP (500) to separate H₂ and N₂, thereby generating a H₂-containing gas stream (2000) and a first N₂-containing gas stream (2100). In some embodiments, the polisher (400) is a water-based ammonia absorber or a pressure swing adsorption (PSA) based ammonia adsorber. In further embodiments, the polisher (400) is a PSA based ammonia adsorber. In some embodiments, the SEP (500) is a PSA-based selective nitrogen adsorber or a PSA-based selective hydrogen adsorber. In some embodiments, the NH₃ recycle stream (1700) is configured to flow into the ammonia source via a throttling valve (300-3).

In some embodiments, the N₂-containing adsorbent and the catalyst present in the first fluidized bed reactor (100) after decomposing NH₃ is in fluid and/or mass communication with the second fluidized bed reactor (200). In some embodiments, the N₂-containing adsorbent and the catalyst are introduced from the solid product outlet (112) of the first fluidized bed reactor (100) into the solid product inlet (210) of the second fluidized bed reactor (200). In some embodiments, the first N₂-containing gas stream (2100) is combined with a N₂ gas stream (2200). The N₂ gas stream (2200) is introduced into the second fluidized bed reactor (200) via the first N₂ gas inlet (204), thereby contacting the N₂ with the N₂-containing adsorbent and the catalyst. In some embodiments, the second fluidized bed reactor (200) acts as a regenerator and is configured to separate the N₂ from the N₂-containing adsorbent, thereby regenerating the adsorbent (102) to form a regenerated adsorbent stream (1400) and a second N₂-containing stream (2300) leaving the second fluidized bed reactor (200) via the N₂ gas outlet (208). In some embodiments, the second N₂-containing stream (2300) and the N₂ gas stream (2200) share a same nitrogen source.

In some embodiments, the regenerated adsorbent stream (1400) containing the adsorbent (102) and the catalyst (104) is introduced from the regenerated solid product outlet (206) of the second fluidized bed reactor (200) into the second inlet (108) of the first fluidized bed reactor (100). In some embodiments, the second NH₃-containing stream (1300) is combined with the regenerated adsorbent stream (1400) before entering the first fluidized bed reactor (100). In further embodiments, the second NH₃-containing stream (1300) is introduced into the first fluidized bed reactor (100) after the introducing of the regenerated adsorbent stream (1400).

In some embodiments, the second fluidized bed reactor (200) acting as a regenerator is operated in a pressure-swing process, therefore the pressure is varied based upon the adsorption characteristics of the adsorbent. In further embodiments, the second fluidized bed reactor (200) acting as a regenerator is operated in a temperature-swing based process, therefore the temperature of the adsorbent is varied in the regenerator based upon the variation in the adsorption-desorption characteristics of the adsorbent with temperature.

Also provided is a method for decomposing ammonia NH₃ to N₂ and H₂. In some embodiments, the method for decomposing NH₃ to N₂ and H₂ is performed using the system 5000. The method includes introducing an NH₃-containing gas stream into the first fluidized bed reactor of the system 5000 via the first NH₃ gas inlet. The method further includes contacting the NH₃-containing gas stream with the adsorbent and the catalyst homogenously distributed thorough the first fluidized bed reactor, thereby generating to N₂ and H₂. The method further includes collecting N₂ and H₂, respectively.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### Embodiments

Embodiment 1: A fixed adsorbent and catalyst bed containing system for ammonia (NH₃) decomposition, comprising:
two or more first reactors in a reaction mode (RM) that are placed parallel to each other, wherein each of the two or more first reactors comprises a first gas inlet, a first gas outlet, and a first fixed adsorbent and catalyst bed comprising a catalyst for decomposing NH₃ to a gas mixture comprising nitrogen (N₂) and hydrogen (H₂), and a N₂ selective adsorbent for in-situ adsorbing N₂ from the gas mixture to form a product gas stream leaving the first reactor from the first gas outlet; and
two or more second reactors in a regeneration mode (RGM) that are placed parallel to each other, wherein each of the two or more second reactors comprises a second gas inlet, a second gas outlet, and a second fixed adsorbent and catalyst bed comprising a spent catalyst and a N₂-containing adsorbent;
wherein the two or more first reactors in the RM mode and the two or more second reactors in the RGM mode are sequentially operable and positioned in parallel, wherein the two or more first reactors are configured to simultaneously in-situ decompose NH₃ and selectively adsorb N₂ in the first fixed adsorbent and catalyst bed, and wherein the two or more second reactors are configured to continuously regenerate the catalyst from the spent catalyst and the N₂ selective adsorbent from the N₂-containing adsorbent in the second fixed adsorbent and catalyst bed; and
wherein the two or more first reactors are changed to the RGM mode after decomposing the NH₃, and the two or more second reactors are changed to the RM mode at a substantially same time when the two or more first reactors are changed to the RGM mode.
   Embodiment 2: The system of embodiment 1, wherein the two or more first reactors share a same ammonia source, and wherein the ammonia source is in fluid communication with each of the two or more first reactors via the first gas inlet.
   Embodiment 3: The system of embodiment 1 or 2, wherein the N₂ selective adsorbent present in the two or more first reactors is in the form of particles having an average particle size ranging from about 100 nanometers (nm) to about 10 micrometers (μm).
   Embodiment 4: The system of any one of embodiments 1-3, wherein the N₂ selective adsorbent present in the two or more first reactors has a surface area of about 600 to about 4500 square meters per gram (m²/g).
   Embodiment 5: The system of any one of embodiments 1-4, wherein the N₂ selective adsorbent present in the two or more first reactors is selected from the group consisting of metal organic frameworks (MOFs), covalent organic frameworks (COFs), zeolitic imidazolate frameworks (ZIFs), and combinations thereof.
   Embodiment 6: The system of any one of embodiments 1-5, wherein the N₂ selective adsorbent present in the two or more first reactors is a MOF, and wherein the MOF comprises at least one metal selected from the group consisting of titanium, vanadium, chromium, manganese, iron, cobalt, nickel, and copper.
   Embodiment 7: The system of any one of embodiments 1-6, wherein the catalyst present in the two or more first reactors comprises three metals selected from the group consisting of barium (Ba), cobalt (Co), cerium (Ce), nickel (Ni), ruthenium (Ru), iron (Fe), platinum (Pt), palladium (Pd), rhodium (Rh), molybdenum (Mo), copper (Cu), and vanadium (V).
   Embodiment 8: The system of any one of embodiments 1-7, further comprising a plurality of throttling valves, two polishers, and two separators (SEPs).
   Embodiment 9: The system of any one of embodiments 1-8, wherein the first gas outlet of the first reactor in the RM mode is in fluid communication with a first polisher via at least one of the plurality of throttling valves, and wherein the first polisher separates unreacted NH₃ from the product gas stream originated from the first gas outlet, thereby generating a first polished product gas stream containing H₂ and N₂.
   Embodiment 10: The system of any one of embodiments 1-9, wherein the first polisher is a water-based ammonia absorber or a pressure swing adsorption (PSA) based ammonia adsorber.
   Embodiment 11: The system of any one of embodiments 1-10, wherein the first polished product gas stream is introduced into a first SEP to separate H₂ and N₂, thereby generating a H₂-containing gas stream and a first N₂-containing gas stream.
   Embodiment 12: The system of any one of embodiments 1-11, wherein the two or more second reactors in the RGM mode share a same nitrogen source, and wherein the nitrogen source is in fluid communication with each of the two or more second reactors in the RGM mode via the second gas inlet.
   Embodiment 13: The system of any one of embodiments 1-12, wherein the second gas outlet of the second reactor in the RGM mode is in fluid communication with a second polisher via at least one of the plurality of throttling valves, and wherein the second polisher is in fluid communication with a second SEP.
   Embodiment 14: The system of any one of embodiments 1-13, wherein the two or more second reactors in the RGM mode are heated during regeneration of the catalyst and adsorbent in the second fixed adsorbent and catalyst bed.
   Embodiment 15: The system of any one of embodiments 1-14, wherein the two or more second reactors in the RGM mode are pressurized during regeneration of the catalyst and adsorbent in the second fixed adsorbent and catalyst bed.
   Embodiment 16: The system of any one of embodiments 1-15, wherein the adsorbent of the second fixed adsorbent and catalyst bed after the regeneration has an average particle size ranging from about 100 nm to about 10 μm and a surface area of about 600 to about 4500 m²/g.
   Embodiment 17: The system of any one of embodiments 1-16, wherein the adsorbent in the first fixed adsorbent and catalyst bed is saturated with N₂ at a substantially same time as the regeneration of the adsorbent in the second fixed adsorbent and catalyst bed.
   Embodiment 18: A method for decomposing ammonia (NH₃) to nitrogen (N₂) and hydrogen (H₂), the method comprising:
splitting and introducing an NH₃-containing feed gas stream into two of more first reactors in a reaction (RM) mode via a first gas inlet, wherein each of the two of more first reactors in the RM mode comprises the first gas inlet, a first gas outlet, and a first fixed adsorbent and catalyst bed comprising a catalyst for decomposing NH₃ to a gas mixture comprising N₂ and H₂, and a N₂ selective adsorbent for in-situ adsorbing N₂ from the gas mixture;
contacting the NH₃-containing feed gas with the catalyst and adsorbent disposed in the first fixed adsorbent and catalyst bed to form a first N₂-containing adsorbent and a product gas stream leaving the first reactor in the RM mode via the first gas outlet;
at a substantially same time of the splitting and introducing the NH₃-containing feed gas stream, splitting and introducing a N₂-containing feed gas stream into two or more second reactors in the regeneration mode (RGM) via a second gas inlet, wherein each of the two or more second reactors in the RGM mode comprises the second gas inlet, a second gas outlet, and a second fixed adsorbent and catalyst bed comprising an NH₃-containing spent catalyst and a second N₂-containing adsorbent;
heating or pressurizing the second fixed adsorbent and catalyst bed to release the N₂ from the second N₂-containing adsorbent and the NH₃ from the NH₃-containing spent catalyst, thereby regenerating the N₂ selective adsorbent and the catalyst; and
changing the two or more first reactors to the RGM mode after the decomposing the NH₃, and the two or more second reactors to the RM mode at a substantially same time, wherein the two or more first reactors and the two or more second reactors are sequentially operable and positioned in parallel.
   Embodiment 19: The method of embodiment 18, further comprising:
introducing the product gas stream from the two or more first reactors in the RM mode to a first polisher via one of the plurality of throttling valves, wherein the first polisher is configured to separate unreacted NH₃ from the product gas stream and form a first polished product gas stream containing H₂ and N₂; and
introducing the first polished product gas stream into a first separator (SEP) to separate H₂ and N₂, thereby generating a H₂-containing gas stream and a first N₂-containing gas stream.
   Embodiment 20: The method of embodiment 18 or 19, further comprising:
introducing the first N₂-containing gas stream into the two or more second reactors in the RGM mode via the second gas inlet;
combining the first N₂-containing gas stream, the N₂ released from the second N₂-containing adsorbent, and the NH₃ released from the NH₃-containing spent catalyst to form a N₂-containing product gas stream leaving the second reactor via the second gas outlet; and
introducing the N₂-containing product gas stream into a second polisher via one of the plurality of throttling valves, wherein the second polisher is configured to separate NH₃ from the N₂-containing product gas stream.
   Embodiment 21: A moving adsorbent bed and fixed catalyst bed containing system, comprising:
a reactor in the form of a cylinder having a central longitudinal axis, wherein the reactor comprises a perforated cylindrical tube at the center of the reactor extending along the central longitudinal axis and a cavity formed between an outer side wall of the perforated cylindrical tube and an inner side wall of the reactor;
an ammonia (NH₃) gas inlet disposed at an uppermost point of the perforated cylindrical tube;
a product gas stream outlet disposed at the bottommost point of the perforated cylindrical tube;
an adsorbent inlet at the uppermost point of the cavity; and
an adsorbent outlet at the bottommost point of the cavity;
wherein an NH₃ decomposition catalyst is uniformly distributed throughout the perforated cylindrical tube, thereby forming the fixed catalyst bed; and
wherein an adsorbent is uniformly distributed throughout the cavity, thereby forming the moving adsorbent bed.
   Embodiment 22: The system of embodiment 21, wherein a mean particle size of the adsorbent is at least about 10% larger than an average hole size of the perforated cylindrical tube.
   Embodiment 23: The system of embodiment 21 or 22, wherein an NH₃ source is in fluid communication with the reactor via the NH₃ gas inlet.
   Embodiment 24: The system of any one of embodiments 21-23, further comprising:
a waste heat recovery unit (WHR);
a separator (SEP);
a regenerator;
a regenerator pump; and
a polisher;
wherein the WHR is in thermal communication with the regenerator.
   Embodiment 25: The system of any one of embodiments 21-24, wherein the reactor is in fluid communication with the WHR via the product gas stream outlet, and wherein the WHR is in fluid communication with the polisher.
   Embodiment 26: The system of any one of embodiments 21-25, wherein the reactor is in mass and fluid communications with the SEP via the adsorbent outlet, wherein the SEP is in fluid communication with the polisher, and wherein the SEP is in mass communication with the regenerator.
   Embodiment 27: The system of any one of embodiments 21-26, wherein the regenerator is in mass communication with the cavity of the reactor via the adsorbent inlet.
   Embodiment 28: A method for decomposing ammonia (NH₃), the method comprising:
introducing an NH₃-containing gas stream into the reactor of the system of embodiment 21 via the NH₃ gas inlet; and
contacting the NH₃-containing gas stream with the NH₃ decomposition catalyst disposed on the fixed catalyst bed, thereby generating N₂ and H₂.
   Embodiment 29: A moving adsorbent bed and fixed catalyst bed containing system, comprising:
a reactor in the form of a cylinder having a central longitudinal axis, wherein the reactor comprises a perforated cylindrical tube at the center of the reactor extending along the central longitudinal axis and a cavity formed between an outer side wall of the perforated cylindrical tube and an inner side wall of the reactor;
an ammonia (NH₃) gas inlet disposed at an uppermost point of the cavity;
a product gas stream outlet disposed at the bottommost point of the cavity;
an adsorbent inlet at the uppermost point of the perforated cylindrical tube; and
an adsorbent outlet at the bottommost point of the perforated cylindrical tube;
wherein an NH₃ decomposition catalyst is uniformly distributed throughout the cavity, thereby forming the fixed catalyst bed; and
wherein an adsorbent is uniformly distributed throughout the perforated cylindrical tube, thereby forming the moving adsorbent bed.
   Embodiment 30: The system of embodiment 29, wherein a mean particle size of the adsorbent is at least 10% larger than an average hole size of the perforated cylindrical tube.
   Embodiment 31: The system of embodiment 29 or 30, wherein an NH₃ source is in fluid communication with the reactor via the NH₃ gas inlet.
   Embodiment 32: The system of any one of embodiments 29-31, further comprising:
a waste heat recovery unit (WHR);
a separator (SEP);
a regenerator;
a regenerator pump; and
a polisher;
wherein the WHR is in thermal communication with the regenerator.
   Embodiment 33: The system of any one of embodiments 29-32, wherein the reactor is in fluid communication with the WHR via the product gas stream outlet, and wherein the WHR is in fluid communication with the polisher.
   Embodiment 34: The system of any one of embodiments 29-33, wherein the reactor is in mass and fluid communications with the SEP via the adsorbent outlet, wherein the SEP is in fluid communication with the polisher, and wherein the SEP is in mass communication with the regenerator.
   Embodiment 35: The system of any one of embodiments 29-34, wherein the regenerator is in mass communication with the perforated cylindrical tube of the reactor via the adsorbent inlet.
   Embodiment 36: A method for decomposing ammonia (NH₃), the method comprising:
introducing an NH₃-containing gas stream into the reactor of the system of embodiment 29 via the NH₃ gas inlet; and
contacting the NH₃-containing gas stream with the NH₃ decomposition catalyst disposed on the fixed catalyst bed, thereby generating N₂ and H₂.
   Embodiment 37: A dual fluidized bed containing system, comprising:
a first fluidized bed reactor in the form of a cylinder having a first ammonia (NH₃) gas inlet disposed at a first bottom point of the first fluidized bed reactor, a second inlet disposed at a second bottom point of the first fluidized bed reactor, a product gas stream outlet disposed at a top point of the first fluidized bed reactor, a solid product outlet disposed on an outer side wall of an upper body portion of the first fluidized bed reactor, an adsorbent, and a catalyst; and
a second fluidized bed reactor in the form of a cylinder having a first N₂ gas inlet disposed at a first bottom point of the second fluidized bed reactor, a regenerated solid product outlet disposed at a second bottom point of the second fluidized bed reactor, a N₂ gas outlet disposed at a first top point of the second fluidized bed reactor, and a solid product inlet disposed on an outer side wall of a lower body portion of the second fluidized bed reactor;
wherein the first fluidized bed reactor and the second fluidized bed reactor are positioned parallel to each other in the same horizontal plane; and
wherein the solid product outlet of the first fluidized bed reactor is located at a position higher than the solid product inlet of the second fluidized bed reactor relative to the same horizontal plane of the first fluidized reactor and the second fluidized reactor.
   Embodiment 38: The system of embodiment 37, wherein the adsorbent and the catalyst are homogenously distributed thorough the first fluidized bed reactor.
   Embodiment 39: The system of embodiment 37 or 38, further comprising:
a polisher;
a separator (SEP); and
a plurality of throttling valves.
   Embodiment 40: A method for decomposing ammonia (NH₃), the method comprising:
introducing an NH₃-containing gas stream into the first fluidized bed reactor of the system of embodiment 37 via the first NH₃ gas inlet; and
contacting the NH₃-containing gas stream with the adsorbent and the catalyst homogenously distributed thorough the first fluidized bed reactor, thereby generating to N₂ and H₂.

1. A fixed adsorbent and catalyst bed containing system for ammonia (NH₃) decomposition, comprising:
two or more first reactors in a reaction mode (RM) that are placed parallel to each other, wherein each of the two or more first reactors comprises a first gas inlet, a first gas outlet, and a first fixed adsorbent and catalyst bed comprising a catalyst for decomposing NH₃ to a gas mixture comprising nitrogen (N₂) and hydrogen (H₂), and a N₂ selective adsorbent for in-situ adsorbing N₂ from the gas mixture to form a product gas stream leaving the first reactor from the first gas outlet; and
two or more second reactors in a regeneration mode (RGM) that are placed parallel to each other, wherein each of the two or more second reactors comprises a second gas inlet, a second gas outlet, and a second fixed adsorbent and catalyst bed comprising a spent catalyst and a N₂-containing adsorbent;
wherein the two or more first reactors in the RM mode and the two or more second reactors in the RGM mode are sequentially operable and positioned in parallel, wherein the two or more first reactors are configured to simultaneously in-situ decompose NH₃ and selectively adsorb N₂ in the first fixed adsorbent and catalyst bed, and wherein the two or more second reactors are configured to continuously regenerate the catalyst from the spent catalyst and the N₂ selective adsorbent from the N₂-containing adsorbent in the second fixed adsorbent and catalyst bed; and
wherein the two or more first reactors are changed to the RGM mode after decomposing the NH₃, and the two or more second reactors are changed to the RM mode at a substantially same time when the two or more first reactors are changed to the RGM mode.

2. The system of claim 1, wherein the two or more first reactors share a same ammonia source, and wherein the ammonia source is in fluid communication with each of the two or more first reactors via the first gas inlet.

3. The system of claim 1, wherein the N₂ selective adsorbent present in the two or more first reactors is in the form of particles having an average particle size ranging from about 100 nanometers (nm) to about 10 micrometers (μm).

4. The system of claim 1, wherein the N₂ selective adsorbent present in the two or more first reactors has a surface area of about 600 to about 4500 square meters per gram (m²/g).

5. The system of claim 1, wherein the N₂ selective adsorbent present in the two or more first reactors is selected from the group consisting of metal organic frameworks (MOFs), covalent organic frameworks (COFs), zeolitic imidazolate frameworks (ZIFs), and combinations thereof.

6. The system of claim 5, wherein the N₂ selective adsorbent present in the two or more first reactors is a MOF, and wherein the MOF comprises at least one metal selected from the group consisting of titanium, vanadium, chromium, manganese, iron, cobalt, nickel, and copper.

7. The system of claim 1, wherein the catalyst present in the two or more first reactors comprises three metals selected from the group consisting of barium (Ba), cobalt (Co), cerium (Ce), nickel (Ni), ruthenium (Ru), iron (Fe), platinum (Pt), palladium (Pd), rhodium (Rh), molybdenum (Mo), copper (Cu), and vanadium (V).

8. The system of claim 1, further comprising a plurality of throttling valves, two polishers, and two separators (SEPs).

9. The system of claim 8, wherein the first gas outlet of the first reactor in the RM mode is in fluid communication with a first polisher via at least one of the plurality of throttling valves, and wherein the first polisher separates unreacted NH₃ from the product gas stream originated from the first gas outlet, thereby generating a first polished product gas stream containing H₂ and N₂.

10. The system of claim 8, wherein the first polisher is a water-based ammonia absorber or a pressure swing adsorption (PSA) based ammonia adsorber.

11. The system of claim 8, wherein the first polished product gas stream is introduced into a first SEP to separate H₂ and N₂, thereby generating a H₂-containing gas stream and a first N₂-containing gas stream.

12. The system of claim 1, wherein the two or more second reactors in the RGM mode share a same nitrogen source, and wherein the nitrogen source is in fluid communication with each of the two or more second reactors in the RGM mode via the second gas inlet.

13. The system of claim 8, wherein the second gas outlet of the second reactor in the RGM mode is in fluid communication with a second polisher via at least one of the plurality of throttling valves, and wherein the second polisher is in fluid communication with a second SEP.

14. The system of claim 1, wherein the two or more second reactors in the RGM mode are heated during regeneration of the catalyst and adsorbent in the second fixed adsorbent and catalyst bed.

15. The system of claim 1, wherein the two or more second reactors in the RGM mode are pressurized during regeneration of the catalyst and adsorbent in the second fixed adsorbent and catalyst bed.

16. The system of claim 1, wherein the adsorbent of the second fixed adsorbent and catalyst bed after the regeneration has an average particle size ranging from about 100 nm to about 10 μm and a surface area of about 600 to about 4500 m²/g.

17. The system of claim 1, wherein the adsorbent in the first fixed adsorbent and catalyst bed is saturated with N₂ at a substantially same time as the regeneration of the adsorbent in the second fixed adsorbent and catalyst bed.

18. A method for decomposing ammonia (NH₃) to nitrogen (N₂) and hydrogen (H₂), the method comprising:
splitting and introducing an NH₃-containing feed gas stream into two of more first reactors in a reaction (RM) mode via a first gas inlet, wherein each of the two of more first reactors in the RM mode comprises the first gas inlet, a first gas outlet, and a first fixed adsorbent and catalyst bed comprising a catalyst for decomposing NH₃ to a gas mixture comprising N₂ and H₂, and a N₂ selective adsorbent for in-situ adsorbing N₂ from the gas mixture;
contacting the NH₃-containing feed gas with the catalyst and adsorbent disposed in the first fixed adsorbent and catalyst bed to form a first N₂-containing adsorbent and a product gas stream leaving the first reactor in the RM mode via the first gas outlet;
at a substantially same time of the splitting and introducing the NH₃-containing feed gas stream, splitting and introducing a N₂-containing feed gas stream into two or more second reactors in the regeneration mode (RGM) via a second gas inlet, wherein each of the two or more second reactors in the RGM mode comprises the second gas inlet, a second gas outlet, and a second fixed adsorbent and catalyst bed comprising an NH₃-containing spent catalyst and a second N₂-containing adsorbent;
heating or pressurizing the second fixed adsorbent and catalyst bed to release the N₂ from the second N₂-containing adsorbent and the NH₃ from the NH₃-containing spent catalyst, thereby regenerating the N₂ selective adsorbent and the catalyst; and
changing the two or more first reactors to the RGM mode after the decomposing the NH₃, and the two or more second reactors to the RM mode at a substantially same time, wherein the two or more first reactors and the two or more second reactors are sequentially operable and positioned in parallel.

19. The method of claim 18, further comprising:
introducing the product gas stream from the two or more first reactors in the RM mode to a first polisher via one of the plurality of throttling valves, wherein the first polisher is configured to separate unreacted NH₃ from the product gas stream and form a first polished product gas stream containing H₂ and N₂; and
introducing the first polished product gas stream into a first separator (SEP) to separate H₂ and N₂, thereby generating a H₂-containing gas stream and a first N₂-containing gas stream.

20. The method of claim 19, further comprising:
introducing the first N₂-containing gas stream into the two or more second reactors in the RGM mode via the second gas inlet;
combining the first N₂-containing gas stream, the N₂ released from the second N₂-containing adsorbent, and the NH₃ released from the NH₃-containing spent catalyst to form a N₂-containing product gas stream leaving the second reactor via the second gas outlet; and
introducing the N₂-containing product gas stream into a second polisher via one of the plurality of throttling valves, wherein the second polisher is configured to separate NH₃ from the N₂-containing product gas stream.

21. A moving adsorbent bed and fixed catalyst bed containing system, comprising:
a reactor in the form of a cylinder having a central longitudinal axis, wherein the reactor comprises a perforated cylindrical tube at the center of the reactor extending along the central longitudinal axis and a cavity formed between an outer side wall of the perforated cylindrical tube and an inner side wall of the reactor;
an ammonia (NH₃) gas inlet disposed at an uppermost point of the perforated cylindrical tube;
a product gas stream outlet disposed at the bottommost point of the perforated cylindrical tube;
an adsorbent inlet at the uppermost point of the cavity; and
an adsorbent outlet at the bottommost point of the cavity;
wherein an NH₃ decomposition catalyst is uniformly distributed throughout the perforated cylindrical tube, thereby forming the fixed catalyst bed; and
wherein an adsorbent is uniformly distributed throughout the cavity, thereby forming the moving adsorbent bed.

22. The system of claim 21, wherein a mean particle size of the adsorbent is at least about 10% larger than an average hole size of the perforated cylindrical tube.

23. The system of claim 21, wherein an NH₃ source is in fluid communication with the reactor via the NH₃ gas inlet.

24. The system of claim 21, further comprising:
a waste heat recovery unit (WHR);
a separator (SEP);
a regenerator;
a regenerator pump; and
a polisher;
wherein the WHR is in thermal communication with the regenerator.

25. The system of claim 24, wherein the reactor is in fluid communication with the WHR via the product gas stream outlet, and wherein the WHR is in fluid communication with the polisher.

26. The system of claim 24, wherein the reactor is in mass and fluid communications with the SEP via the adsorbent outlet, wherein the SEP is in fluid communication with the polisher, and wherein the SEP is in mass communication with the regenerator.

27. The system of claim 24, wherein the regenerator is in mass communication with the cavity of the reactor via the adsorbent inlet.

28. A method for decomposing ammonia (NH₃), the method comprising:
introducing an NH₃-containing gas stream into the reactor of the system of claim 21 via the NH₃ gas inlet; and
contacting the NH₃-containing gas stream with the NH₃ decomposition catalyst disposed on the fixed catalyst bed, thereby generating N₂ and H₂.

29. A moving adsorbent bed and fixed catalyst bed containing system, comprising:
a reactor in the form of a cylinder having a central longitudinal axis, wherein the reactor comprises a perforated cylindrical tube at the center of the reactor extending along the central longitudinal axis and a cavity formed between an outer side wall of the perforated cylindrical tube and an inner side wall of the reactor;
an ammonia (NH₃) gas inlet disposed at an uppermost point of the cavity;
a product gas stream outlet disposed at the bottommost point of the cavity;
an adsorbent inlet at the uppermost point of the perforated cylindrical tube; and
an adsorbent outlet at the bottommost point of the perforated cylindrical tube;
wherein an NH₃ decomposition catalyst is uniformly distributed throughout the cavity, thereby forming the fixed catalyst bed; and
wherein an adsorbent is uniformly distributed throughout the perforated cylindrical tube, thereby forming the moving adsorbent bed.

30. The system of claim 29, wherein a mean particle size of the adsorbent is at least 10% larger than an average hole size of the perforated cylindrical tube.

31. The system of claim 29, wherein an NH₃ source is in fluid communication with the reactor via the NH₃ gas inlet.

32. The system of claim 29, further comprising:
a waste heat recovery unit (WHR);
a separator (SEP);
a regenerator;
a regenerator pump; and
a polisher;
wherein the WHR is in thermal communication with the regenerator.

33. The system of claim 32, wherein the reactor is in fluid communication with the WHR via the product gas stream outlet, and wherein the WHR is in fluid communication with the polisher.

34. The system of claim 32, wherein the reactor is in mass and fluid communications with the SEP via the adsorbent outlet, wherein the SEP is in fluid communication with the polisher, and wherein the SEP is in mass communication with the regenerator.

35. The system of claim 32, wherein the regenerator is in mass communication with the perforated cylindrical tube of the reactor via the adsorbent inlet.

36. A method for decomposing ammonia (NH₃), the method comprising:
introducing an NH₃-containing gas stream into the reactor of the system of claim 29 via the NH₃ gas inlet; and
contacting the NH₃-containing gas stream with the NH₃ decomposition catalyst disposed on the fixed catalyst bed, thereby generating N₂ and H₂.

37. A dual fluidized bed containing system, comprising:
a first fluidized bed reactor in the form of a cylinder having a first ammonia (NH₃) gas inlet disposed at a first bottom point of the first fluidized bed reactor, a second inlet disposed at a second bottom point of the first fluidized bed reactor, a product gas stream outlet disposed at a top point of the first fluidized bed reactor, a solid product outlet disposed on an outer side wall of an upper body portion of the first fluidized bed reactor, an adsorbent, and a catalyst; and
a second fluidized bed reactor in the form of a cylinder having a first N₂ gas inlet disposed at a first bottom point of the second fluidized bed reactor, a regenerated solid product outlet disposed at a second bottom point of the second fluidized bed reactor, a N₂ gas outlet disposed at a first top point of the second fluidized bed reactor, and a solid product inlet disposed on an outer side wall of a lower body portion of the second fluidized bed reactor;
wherein the first fluidized bed reactor and the second fluidized bed reactor are positioned parallel to each other in the same horizontal plane; and
wherein the solid product outlet of the first fluidized bed reactor is located at a position higher than the solid product inlet of the second fluidized bed reactor relative to the same horizontal plane of the first fluidized reactor and the second fluidized reactor.

38. The system of claim 37, wherein the adsorbent and the catalyst are homogenously distributed thorough the first fluidized bed reactor.

39. The system of claim 37, further comprising:
a polisher;
a separator (SEP); and
a plurality of throttling valves.

40. A method for decomposing ammonia (NH₃), the method comprising:
introducing an NH₃-containing gas stream into the first fluidized bed reactor of the system of claim 37 via the first NH₃ gas inlet; and
contacting the NH₃-containing gas stream with the adsorbent and the catalyst homogenously distributed thorough the first fluidized bed reactor, thereby generating to N₂ and H₂.
